(19) United States
(12) Patent Application Publication
(10) Pub. No.: US 2023/0420160 A1
(43) Pub. Date: Dec. 28, 2023

(54) SUPERCONDUCTOR TAPE AND A SUPERCONDUCTOR TAPE STACK AND METHODS OF MAKING AND USING THE SAME

(71) Applicants: University of Houston System, Houston, TX (US); AMPeers LLC, Houston, TX (US)

(72) Inventors: Venkat SELVAMANICKAM, Houston, TX (US); Yi LI, Houston, TX (US); Eduard GALSTYAN, Houston, TX (US); Cyrus FUNKHOUSER, Houston, TX (US)

(21) Appl. No.: 18/327,430

(22) Filed: Jun. 1, 2023

Related U.S. Application Data
(60) Provisional application No. 63/365,893, filed on Jun. 6, 2022.

(51) Int. Cl. H01B 12/06; H01B 1/02

(52) U.S. Cl. CPC H01B 12/06; H01B 1/026; H01F 6/06

(57) ABSTRACT

A superconductor tape stack can have good current sharing characteristics and low contact resistivity. An electrically conductive material can be used to couple superconductor tapes to each other. In an embodiment, the superconductor tape stack can include double-sided superconductor tapes in a 2X configuration. In other embodiments, the superconductor tape stack can include single-sided superconductor tapes in a F2B configuration. One or more enhancements may be used to help reduce the contact resistivity. The enhancements can include slotted tapes, a conductive buffer layer stack, a relatively low resistivity substrate, a thinner substrate, a thicker stabilizer layer along sidewalls of the tapes, and combinations thereof. A superconductor tape may also have one or more of the enhancements described with respect to the superconductor tape stack. A magnetic coil can have a winding that includes the superconductor tape stack or the superconductor tape.

### CROSS REFERENCE TO RELATED APPLICATION

This application claims priority under 35 U.S.C. § 119(e) to U.S. Provisional Patent Application No. 63/365,893 entitled “Superconductor Tape and a Superconductor Tape Stack and Methods of Making and Using the Same,” by Venkat Selvamanickam et al., filed Jun. 6, 2022, which is assigned to the current assignees hereof and incorporated herein by reference in its entirety.

### GOVERNMENT LICENSE RIGHTS

This invention was made with government support under contract number N68335-21-C-0525 awarded by the US Department of the Navy. The government has certain rights in the invention.

### FIELD OF THE DISCLOSURE

The present disclosure relates to superconductors, and more particularly to, superconductor tapes and superconductor tape stacks and methods of making and using the same.

### RELATED ART

A High Temperature Superconductor (HTS) material, such as Rare Earth-Barium-Copper-Oxide (REBCO), can operate at relatively higher temperatures (at 77 K), at higher magnetic fields, or both higher temperatures and higher magnetic fields as compared to a Low Temperature Superconductor (LTS) material. Thus, an HTS material can address challenges seen with LTS in magnets where superconductors are used for particle accelerators, fusion energy systems, proton-beam and carbon-beam therapy systems, and coils for electric power devices.

A problem with an HTS is that the Normal Zone Propagation (NZP) velocity is significantly lower (0.01-0.1 m/s) as compared to an LTS. The low NZP velocity results in a slow-spreading normal zone, and thus, a slow increase in fault-induced voltage. Simultaneously, a slow spread of heat results in high local temperatures before the voltage increases sufficiently for external detection. These two effects combined can lead to thermal runaway and catastrophic failure of a coil having REBCO tapes before quench detection.

Ideally, a uniform, a long Rare Earth-Barium-Copper-Oxide (REBCO) tape has no defect. In practice, REBCO tapes have defects, and hot spots can occur. A hot spot is difficult to detect when the REBCO tape is in use.

New designs of REBCO tapes are desired, where such new designs allow long REBCO tapes with more uniform critical current to avoid hot spots, and such new designs can withstand better local defects in REBCO tapes.

### BRIEF DESCRIPTION OF THE DRAWINGS

Embodiments are illustrated by way of example and are not limited in the accompanying figures.

FIG. 1 includes an illustration of a configuration for determining contact resistivity between superconductor tapes as evaluated by measuring the lap joint resistance.

FIG. 2 includes a flow chart for a process of making a superconductor tape.

FIG. 3 includes an illustration of a cross-sectional view of a workpiece after forming a buffer layer stack along a side of a substrate.

FIG. 4 includes an illustration of a cross-sectional view of another workpiece after forming buffer layer stacks along opposite sides of a substrate.

FIG. 5 includes an illustration of a cross-sectional view of the workpiece of FIG. 3 after forming a superconductor film along a side of a substrate.

FIG. 6 includes an illustration of a cross-sectional view of the workpiece of FIG. 4 after forming superconductor films along opposite sides of a substrate.

FIG. 7 includes an image of top views of superconductor tapes with slots that extend through a buffer layer stack and a superconductor film.

FIG. 8 includes an enlarged image of the top superconductor film in FIG. 7.

FIG. 9 includes an enlarged image of the middle superconductor film in FIG. 7.

FIG. 10 includes an enlarged image of the bottom superconductor film in FIG. 7.

FIG. 11 includes an illustration of a cross-sectional view of the workpiece of FIG. 5 after forming a metal layer along exposed surfaces of the workpiece.

FIG. 12 includes an illustration of a cross-sectional view of the workpiece of FIG. 6 after forming a metal layer along exposed surfaces of the workpiece.

FIG. 13 includes an illustration of a cross-sectional view of the workpiece of FIG. 11 after forming a stabilizer layer along exposed surfaces of the workpiece.

FIG. 14 includes an illustration of a cross-sectional view of the workpiece of FIG. 12 after forming a stabilizer layer along exposed surfaces of the workpiece.

FIG. 15 includes an illustration of a cross-sectional view of the workpiece of FIG. 13 having slots that extend through the buffer layer stack and the stabilizer layer.

FIG. 16 includes a flow chart for a process of making a superconductor tape stack.

FIG. 17 includes an illustration of a cross-sectional view of a superconductor tape stack that includes single-sided superconductor tapes in a face-to-back configuration and a conductive material that couples the superconductor tapes together.

FIG. 18 includes an illustration of a cross-sectional view of a superconductor tape stack that includes double-sided superconductor tapes and a conductive material that couples the superconductor tapes together.

FIG. 19 includes a schematic view of a magnetic coil being wound with superconductor tapes and a layer of an electrically conductive material.

FIG. 20 includes an image of a top view of a defective superconductor tape and a normal superconductor tape.

FIG. 21 includes a circuit representation of the superconductor tape stack of FIG. 17, where one of the superconductor films has a defect.

FIG. 22 includes current-voltage curves for the defective superconductor tape in the superconductor tape stack of FIG. 17.

FIG. 23 includes current-voltage curves for the normal superconductor tape in the superconductor tape stack of FIG. 17.

FIG. 24 includes a circuit representation of the superconductor tape stack of FIG. 18, where one of the superconductor films has a defect.

FIG. 25 includes current-voltage curves for the superconductor tape stack of FIG. 18, where one of the superconductor films has a defect.

FIG. 26 includes current-voltage curves for the defective superconductor tape in the superconductor tape stack of FIG. 17, where the superconductor tape stack has slotted superconductor tapes.

FIG. 27 includes current-voltage curves for the normal superconductor tape in the superconductor tape stack of FIG. 17, where the superconductor tape stack has slotted superconductor tapes.

FIG. 28 includes plots of contact resistivity as a function of resistivity of the substrates in the superconductor tape stacks of FIGS. 17 and 18 for different constructions of superconductor tape stacks.

FIG. 29 includes plots of contact resistivity as a function of thickness of the substrates in the superconductor tape stacks of FIGS. 17 and 18 for different constructions of superconductor tape stacks.

FIG. 30 includes plots of contact resistivity as a function of number of slots in the superconductor tapes in the superconductor tape stacks of FIGS. 17 and 18 for different constructions of superconductor tape stacks.

FIG. 31 includes plots of contact resistivity as a function of thickness of the stabilizer layer and depth of two slots in the superconductor tapes in the superconductor tape stacks of FIGS. 17 and 18 for different constructions of superconductor tape stacks.

FIG. 32 includes plots of contact resistivity as a function of thickness of the stabilizer layer and depth of four slots in the superconductor tapes in the superconductor tape stacks of FIGS. 17 and 18 for different constructions of superconductor tape stacks.

FIG. 33 includes plots of contact resistivity as a function of thickness of the stabilizer layer and depth of eight slots in the superconductor tapes in the superconductor tape stacks of FIGS. 17 and 18 for different constructions of superconductor tape stacks.

FIG. 34 includes plots of contact resistivity as a function of resistivity of the buffer layer stack in the superconductor tape stacks of FIGS. 17 and 18 for different constructions of superconductor tape stacks.

FIG. 35 includes plots of contact resistivity as a function of resistivity of the buffer layer stack for superconductor tapes having two slots in the superconductor tape stack of FIG. 17 for different substrate materials.

FIG. 36 includes plots of contact resistivity as a function of resistivity of the buffer layer stack for superconductor tapes having four slots in the superconductor tape stack of FIG. 17 for different substrate materials.

FIG. 37 includes plots of contact resistivity as a function of resistivity of the buffer layer stack for superconductor tapes having eight slots in the superconductor tape stack of FIG. 17 for different substrate materials.

FIG. 38 includes plots of contact resistivity as a function of thickness of the stabilizer layer along sidewalls of the superconductor tapes in the superconductor tape stacks of FIGS. 17 and 18 for different constructions of superconductor tape stacks.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

Regarding dimensions, a superconductor tape strand has a length, a width, and a thickness, where length<width<thickness.

The term “rare earth” or “rare earth element” is intended to mean Y, Sc, and the Lanthanides (La to Lu) in the Periodic Table of the Elements.

Group numbers correspond to columns within the Periodic Table of Elements based on the IUPAC Periodic Table of Elements, version dated Dec. 1, 2018.

The terms “on,” “overlying,” and “over” may be used to indicate that two or more physical objects are in direct physical contact with each other. However, “over” may also mean that two or more objects are not in direct contact with each other. For example, “over” may mean that one object is above another object, but the objects do not contact each other and may have another object or objects in between the two objects.

The term “along” may be used to indicate that two or more physical objects have lengths that extend in a same direction and are in direct physical contact with each other. However, “along” may also mean that two or more objects have lengths that extend in the same direction but are not in direct contact with each other. Thus, “along” may mean that an intermediate object is disposed between the two objects. For example, a first layer can be along a second layer, wherein the first layer and the second layer have lengths that extend in the same direction, even though an intermediate layer is disposed between the first layer and the second layer.

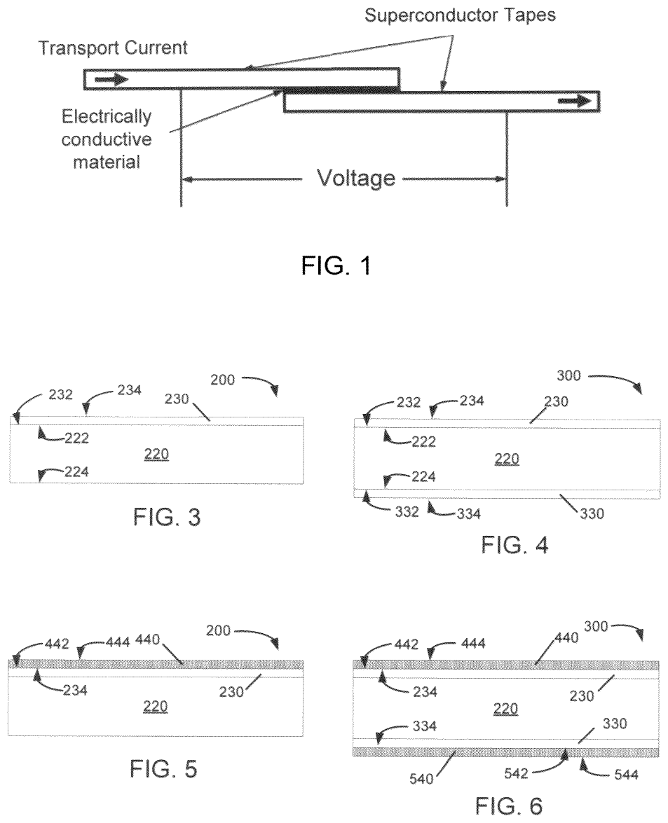

Contact resistivity between superconductor tapes is evaluated by measuring the lap joint resistance. As shown in FIG. 1, two segments of superconductor tape with a width of 4 mm are placed in parallel with 50-mm-length overlap, achieving a 2-cm² contacting area. The resistance of the lap joint is measured using 4-probe method with the joint area between a pair of voltage taps separated over a distance of 8 cm. The resistance, R, is determined by the slope of current-voltage (I-V) curve, and resistivity is R times the contact area. The I-V curve is generated from measurements are taken 20° C.

Resistivities of materials are measured at 20° C.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

The term “significantly different” is intended to mean that a value of a variable (e.g., length, width, etc.) is greater than ten percent (10%) (and more than twenty percent (20%) for impurity concentrations) as compared to a different value of the same variable.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the superconductor arts.

A superconductor tape stack can include at least two tapes that are configured to have improved current sharing characteristics. The current sharing characteristics can allow current flowing through the superconductor tape stack to exceed or at least be closer to a desired critical current, when a superconductor tape within the superconductor tape stack has a defect. The superconductor tape stack can include at least two superconductor tapes that have superconductor films on both sides of the tapes or can include at least two superconductor tapes that are arranged in a face-to-back configuration. Although not required in all embodiments, current sharing can be improved by using a more conductive substrate, a conductive buffer layer stack, cutting at least one slot through a superconductor film and its corresponding buffer layer stack and filling the slot with a conductive material, a relatively thinner substrate, a relatively thicker stabilizer layer along sidewalls of the superconductor tape, or using double-sided superconductor tapes. Two or more of the superconductor tapes can be joined together by an electrically conductive material. Many of the enhancements described with respect to superconductor tape stacks may also be used in a superconductor tape outside of a stack.

In an aspect, a superconductor tape stack can include a first superconductor tape and a second superconductor tape. The first superconductor tape and the second superconductor tape can be arranged in a face-to-back configuration, and the superconductor tape stack can have a contact resistivity of at most 700 nΩcm².

In another aspect, a superconductor tape stack can include a first superconductor tape and a second superconductor tape, wherein each of the first superconductor tape and the second superconductor tape includes a substrate. The first superconductor tape and the second superconductor tape can be arranged in a face-to-back configuration. The substrate of the first superconductor tape, the second superconductor tape, or each of the first superconductor tape and the second superconductor tape can have a resistivity of at most 50 μΩcm.

In still another aspect, a superconductor tape stack can include a first superconductor tape and a second superconductor tape, wherein each of the first superconductor tape and the second superconductor tape includes a substrate and a buffer layer stack along a side of the substrate. The first superconductor tape and the second superconductor tape can be arranged in a face-to-back configuration. The buffer layer stack of the first superconductor tape, the second superconductor tape, or each of the first superconductor tape and the second superconductor tape can have a resistivity of at most 1×10⁸ μΩcm.

In yet another aspect, a superconductor tape stack can include a first superconductor tape and a second superconductor tape, wherein each of the first superconductor tape and the second superconductor tape includes a buffer layer stack and a REBCO film. The first superconductor tape and the second superconductor tape can be arranged in a face-to-back configuration. A first slot can extend through a REBCO film and a buffer layer stack of the first superconductor tape, the second superconductor tape, or each of the first superconductor tape and the second superconductor tape. A conductive material can at least partly fill the first slot, wherein the conductive material has a resistivity less than 1 mΩcm. A critical current of the first superconductor tape, the second superconductor tape, or each of the first superconductor tape and the second superconductor tape having the slot can be at least 80 A/4 mm width at 77 K, 0 T.

In a further aspect, a superconductor tape stack can include a first superconductor tape and a second superconductor tape. The first superconductor tape, the second superconductor tape, or each of the first superconductor tape and the second superconductor tape can include a substrate having a first side and a second side opposite the first side; a first REBCO film along the first of the substrate; and a second REBCO film along the second side of the substrate. Each of the first superconductor tape and the second superconductor tape can have a length, at least 11% of the length of the first superconductor tape overlaps the second superconductor tape, and at least 11% of the length of the second superconductor tape is overlapped by the first superconductor tape.

A superconductor tape can include a substrate having a first side and a second side opposite the first side and a superconductor film that is closer to the first side of the substrate than to the second side of the substrate. In an aspect, the substrate can have a resistivity of at most 50 μΩcm. In another aspect, the superconductor tape can further include a stabilizer layer and a layer of an electrically conductive material. The superconductor film can be disposed between the substrate and the stabilizer layer, and the stabilizer layer can be disposed between the superconductor film and the layer of the electrically conductive material. The electrically conductive material can be softer than the stabilizer layer. In still another aspect, the superconductor tape can include a buffer layer stack along the first side of the substrate, wherein the buffer layer stack has a resistivity of at most 1×10⁸ μΩcm. In a further aspect, the superconductor tape can include a buffer layer stack along the first side of the substrate, wherein the buffer layer stack is disposed between the substrate and the superconductor film. The superconductor tape can have a slot that extends through the superconductor film and the buffer layer stack. A conductive material can at least partly fill the slot and has a resistivity of at most 1 mΩcm. The superconductor tape can be a single-sided superconductor tape or a double-sided superconductor tape. A single-sided superconductor tape has a superconductor film along one side of a substrate, and a double-sided superconductor tape has a superconductor film along each of opposite sides of a substrate.

In the description below, the composition and fabrication of single-sided and double-sided superconductor tapes are described before addressing configurations of superconductor tape stacks. With respect to a double-sided tape, buffer layer stacks along opposite sides of a substrate are formed before forming superconductor films. The process description below is based on forming buffer layer stacks before forming the superconductor films. Alternatively, a buffer layer stack and a superconductor film can be formed along one side of a substrate before forming another buffer layer stack and another superconductor film along the opposite side of the superconductor tape. Skilled artisans can determine which process flow is needed or desired for a particular application.

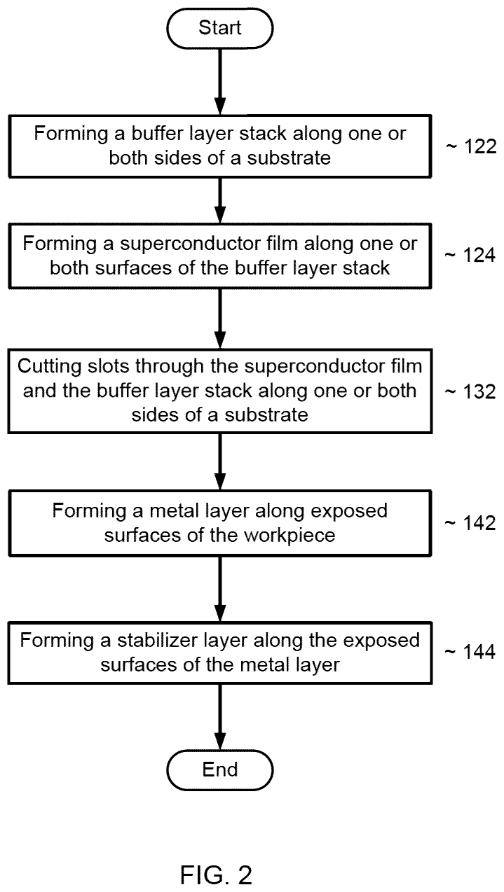

The process can include forming a buffer layer stack along one or both sides of a substrate at block 122 of FIG. 2. FIG. 3 includes a cross-sectional view of a workpiece 200 that includes a substrate 220 and a buffer layer stack 230 for a single-sided tape, and FIG. 4 includes a cross-sectional view of a workpiece 300 that includes a substrate 220 and buffer layer stacks 230 and 330 for a double-sided tape. The substrate 220 has a side 222 and another side 224 opposite the side 222. The substrate 220 can include a nickel alloy. The nickel alloy can be a Hastelloy®-brand alloy available from Haynes Stellite Company, Kokomo, IN, US; an Inconel®-brand alloy or a Monel®-brand alloy, both available from Huntington Alloys Corporation of Huntington, WV, US; stainless steel; or another suitable Ni alloy.

In another embodiment, the substrate 220 can include a conductive metal-refractory metal alloy or composite; a Cu-Be alloy or composite; or another suitable alloy or composite. The conductive metal of the conductive metal-refractory metal alloy or composite has a significantly higher conductivity as compared to the refractory metal. The conductive metal can include Cu or a noble metal, such as Au, Pt, Ir, Os, or Ru. The refractory metal can include W, Ti, or Ta. In a particular embodiment, the substrate 220 can include 20 wt. % Cu to 70 wt. % Cu and 30 wt. % W to 80 wt. % W. The Cu-Be alloy can include at least 95 wt. % Cu, 0.2 wt. % to 2.0 wt. % Be, 0.9 wt. % to 2.5 wt. % of Co, Ni, Fe, or a combination of thereof. The Cu-Be alloy can be a Berylco®-brand alloy available from NKG Metals Corporation, South Sweetwater, TN, US.

For some of the metal combinations above, powders of constituent metals may be mixed and heated. Due to the difference in melting points, a metal with a lower melting point (referred to herein as a “low-temperature metal”) can melt before the melting point of another metal (referred to herein as a “high-temperature metal”) within the mixture melts. Thus, the high-temperature metal may remain as unmelted particles dispersed within the low-temperature metal. The resulting mixed-metal object may be a composite since it may be considered as having different phases.

Although not required in all implementations, substrates with relatively lower resistivity can help to improve current sharing between superconductor tapes within the superconductor tape stacks. Thus, if more current sharing is desired, the substrate 220 can have a resistivity of at most 50 μΩcm. In an embodiment, the substrate can have a resistivity in a range from 2 μΩcm to 50 μΩcm, 2 μΩcm to 30 μΩcm, 2 μΩcm to 20 μΩcm, or 2 μΩcm to 10 μΩcm. Many of the previously described materials, such as the conductive metal-refractory metal alloy or composite, the Cu-Be alloy, the Monel®-brand alloy, and some stainless steels, but not all stainless steels, can meet the resistivity values. Substrate materials with resistivities in a range from 80 μΩcm to 125 μΩcm include stainless steel 316 and some Hastelloy®-brand alloys can have resistivities greater than 50 μΩcm. In some applications, a conductive material with a resistivity higher than 50 μDem, such as stainless steel 316 or a Hastelloy®-brand alloy may be used.

The substrate 220 can have an average surface roughness (Ra) less than 10 nm, less than 5 nm, or less than 3 nm. Thus, the substrate 220 may need to be treated to achieve the desired Ra. For example, the substrate 220 may be polished to improve Ra. Some of the previously described materials may be difficult to polish due to disparate hardness differences between materials within the substrate 220. The conductive metal-refractory metal alloy or composite may be more challenging as compared to some of the other materials.

As a non-limiting example, a substrate 220 can include Cu and W, and different polishing parameters may be used for each of Cu and W. One method that has been used is to polish Cu-W twice. One polishing operation can be tailored to W, and another polishing operation can be tailored to Cu. For example, tungsten can be electropolished first for 200 s using a current density of 8 mA/cm², 0.27 M NaOH electrolyte, and a copper counter electrode. Then, copper can be polished for 600 s using a current density of 8 mA/cm², 14 M H₃PO₄ electrolyte, and a lead counter electrode. Another approach for Cu-W can use a combination of mechanical abrasive polishing and electropolishing. Electropolishing is performed using a reference electrode and another electrode (herein, referred to as the “substrate electrode”) that is electrically connected to the substrate 220. During electropolishing, the voltage polarities of the electrodes are switched back and forth. When Cu is being removed, the reference electrode is the cathode, and the substrate electrode is the anode. When W is being removed, the reference electrode is the anode, and the substrate electrode is the cathode. Thus, during electropolishing, the voltages on the electrodes are switched back and forth. This alternating switching of anode and cathode allows for electropolishing of both Cu and W to occur during the same electropolishing sequence.

Mechanical polishing or Chemical Mechanical polishing can be used instead of or in addition to electropolishing to achieve the desired Ra. The substrate material can be abrasively polished using silicon carbide abrasive sheets followed by sequentially polishing with diamond pastes of 5 micron, 3 micron, and 1 micron particle size, and then an alumina slurry of 0.05 μm particle size.

With respect to thickness of the substrate 220, as the thickness of the substrate 220 becomes thinner, the resistance for current flowing through the substrate 220 is reduced. The thickness of the substrate 220 can be in a range from 10 microns to 100 microns, 20 microns to 70 microns, 20 microns to 50 microns, or 20 microns to 35 microns.

The superconductor tapes can allow for some elastic bending without permanently deforming the superconductor tapes. In an embodiment, the yield strength of the substrate 220 is at least 300 MPa, at least 500 MPa, or at least 700 MPa. In the same or different embodiment, the yield strength is at most 2,500 MPa.

In FIG. 3, the buffer layer stack 230 is disposed along the side 222 of the substrate 220. In FIG. 4, the buffer layer stack 230 is disposed along the side 222 of the substrate 220, and the buffer layer stack 330 is disposed along the side 224 of the substrate 220. The buffer layer stack 230 has a proximal side 232 and a distal side 234 opposite the proximal side 232, where the substrate 220 is closer to the proximal side 232 than to the distal side 234. The buffer layer stack 330 has a proximal side 332 and a distal side 334 opposite the proximal side 332, where the substrate 220 is closer to the proximal side 332 than to the distal side 334.

Each of the buffer layer stacks 230 and 330 allows a subsequently-formed superconductor film to be properly formed. Each of the buffer layer stacks 230 and 330 includes at least one film that is biaxially textured. The buffer layer stacks 230 and 330 can include MgO, LaMnO₃, CeO₂, Gd₂Zr₂O₇, yttria-stabilized zirconia, TiN, LaNiO₃, SrVO₃, SrRuO₃, Nb-doped SrTiO₃, or a combination thereof. Each of the deposited films within the buffer layer stack can have a thickness in a range from 5 nm to 200 nm. The buffer layer stack can have a thickness in a range from 0.1 micron to 2 microns. The buffer layer stack 330 can have the same composition or a different composition as compared to the buffer layer stack 230, and the buffer layer stack 330 can have the same thickness or a different thickness as compared to the buffer layer stack 230.

An exemplary buffer layer stack can include, starting with the film closest to the substrate 220 to the film farthest from the substrate, amorphous Al₂O₃/Y₂O₃/IBAD MgO/Y₂O₃/homo-epitaxial MgO/LaMnO₃, where IBAD is ion-beam-assisted deposition. The previously described composition forms a dielectric buffer layer stack. Although not required in all implementations, a conductive buffer layer stack can help to improve current sharing between superconductor tapes within the superconductor tape stacks. Thus, if more current sharing is desired, one or more of the above-mentioned films in the exemplary buffer layer stack may be partly or completely replaced by TiN, LaNiO₃, SrVO₃, SrRuO₃, Nb-doped SrTiO₃, or a combination thereof. In the exemplary buffer layer stack, Al₂O₃ and MgO have relatively high resistivities. Some or all of the Al₂O₃ can be replaced by TiN, LaNiO₃, SrVO₃, SrRuO₃, Nb-doped SrTiO₃, or a combination thereof. The buffer layer stack has a biaxially textured film to allow a subsequently-formed superconductor film to be formed properly. TiN can be biaxially textured, and thus, IBAD TiN can be used to partly or completely replace the IBAD MgO.

The process can further include forming a superconductor film along one or both surfaces of the buffer layer stack at block 124 of FIG. 2. In FIG. 5, the superconductor film 440 is disposed along the distal side 234 of the buffer layer stack 230. In FIG. 6, the superconductor film 440 is disposed along the distal side 234 of the buffer layer stack 230, and the superconductor film 540 is disposed along the distal side 334 of the buffer layer stack 330. The superconductor film 440 has a proximal side 442 and a distal side 444 opposite the proximal side 442, where the substrate 220 is closer to the proximal side 442 than to the distal side 444. The superconductor film 540 has a proximal side 542 and a distal side 544 opposite the proximal side 542, where the substrate 220 is closer to the proximal side 542 than to the distal side 544.

The superconductor films 440 and 540 include HTS materials. For example, each of the superconductor films 440 and 540 can be a Rare Earth-Barium-Copper-Oxide that is also an HTS material and is herein referred to as “REBCO.” For example, REBCO can be RE₁Ba₂Cu₃O_{7-δ}, where RE is Y, Gd, Sm, Nd, Eu, Dy, Ho, Yb, Er, Tm, Lu, or a combination thereof, and 0.0≤δ≤0.5. In an embodiment, the superconductor films 440 and 540 can have nanoscale defects, where such defects can form when REBCO includes a BaMO₃ phase, where M is Zr, Hf, Sn, or a combination thereof. The superconductor film 440, 540, or both can include a REBCO phase that includes REBCO and a BaMO₃ phase. On an atomic basis, within the superconductor film 440, 540, or both, (Ba+M)/Cu is at least 0.72 and can be in a range from 0.72 to 0.85. On a mole basis, M can be 0.5 mol % to 25 mol % of superconductor film.

The superconductor film 440, 540, or both have a thickness of at least 1.0 micron. In an embodiment, the superconductor film 440, 540, or both have a thickness in a range from 1.0 microns to 6.0 microns. The superconductor film 440, 540, or both can be formed by deposition using metalorganic chemical vapor deposition (MOCVD), pulsed laser deposition, electron-beam evaporation, or metal organic deposition.

The superconductor film 540 can have the same composition or a different composition as compared to the superconductor film 440, and the superconductor film 540 can have the same thickness or a different thickness as compared to the superconductor film 440.

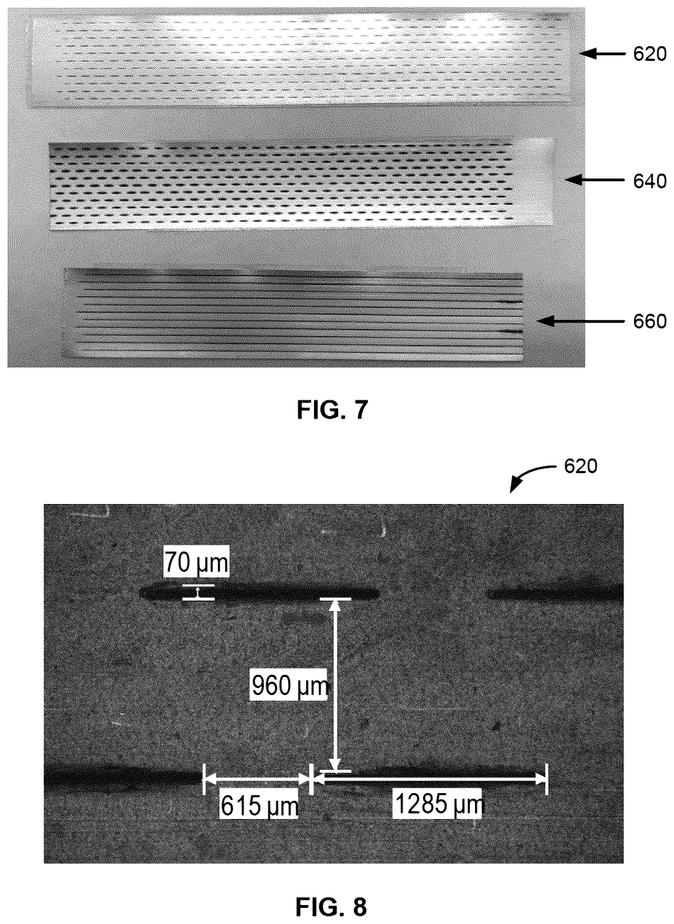

The process can include cutting slots through the superconductor film and the buffer layer stack along one or both sides of a substrate at block 132 in FIG. 2. The slots are not required in all embodiments; however, the slots can help with current sharing. FIG. 7 includes an image that includes a top view of some of the different slot patterns that can be used. Each of the superconductor tapes in FIG. 7 have lengths that are measured in a horizonal direction and widths measured in a vertical direction. Current flows in the length direction when the superconductor tapes are energized. The superconductor tapes in FIG. 7 have widths of 12 mm. The lengths of the slots are in the same direction as the length of the superconductor tapes.

Slots can help with current sharing when there is a defect in the superconductor film of a superconductor tape within a tape stack. However, if the areal density of slots (seen in a top view of a tape) is too high, the superconductor tape may not be able to reach a desired An areal density of slots can be determined by taking a sum of the area occupied by slots for a unit area of a tape (for example, 1 mm×1 mm area of the tape) divided by the unit area of the tape. The areal density can be expressed as a percentage. In an embodiment, the areal density of slots can be in a range from 0.1% to 50%. The top tape 620 in FIG. 7 has the lowest areal density of slots compared to the middle tape 640 and the bottom tape 660, and the bottom tape 660 has the highest areal density of slots as compared to the top tape 620 and the middle tape 640.

The depths of the slots extend at least though the superconductor film and buffer layer stack along one or both sides of the substrate 220 and may extend through an entire thickness of the substrate 220. In general, as the depth of the slots increases, current sharing also increases. Exemplary depths can include 10 microns, 20 microns, 30 microns, 40 microns, 50 microns, 60 microns, or values in between.

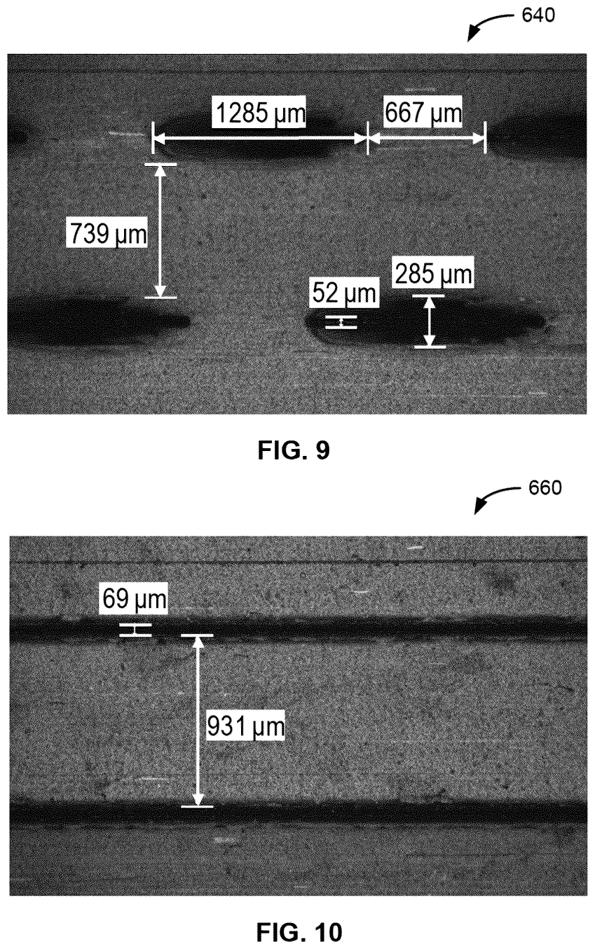

Deeper slots may result in wider slots. The top tape 620 and the middle tape 640 have substantially the same slot pattern. FIGS. 8 and 9 include enlarged images of portions of the superconductor tapes 620 and 640, respectively. Along a row of slots (horizonal direction in FIGS. 8 and 9), the slot pitch for superconductor tapes 620 and 640 is approximately 2.0 mm, with approximately 1.3 mm slots and 0.7 mm spaces. The pitch for the rows of slots (vertical direction in FIGS. 8 and 9), is approximately 1.0 mm. The superconductor tape 620 has 10 μm depth slots, and the slots are approximately 70 μm wide as measured at the top of the slots. The superconductor tape 640 has 25 μm depth slots, and the slots are approximately 300 μm wide as measured at the top of the slots. For the superconductor 620 and 640, the widths of at or near the bottoms of the slots are approximately 50 μm.

Along the rows of slots (horizontal direction in FIG. 7), the superconductor tape 660 has a slot that extends to an end of the tape. Thus, a superconductor tape 660 has continuous, as opposed to spaced-apart slots along the horizonal direction. FIG. 10 includes an enlarged image of a portion of the superconductor tape 660. The pitch for the rows of slots (vertical direction in FIG. 10), is approximately 1.0 mm. Similar to the superconductor tape 620, the superconductor tape 660 has 10 μm depth slots, and the slots are approximately 70 μm wide as measured at the top of the slots. The widths of at or near the bottoms of the slots are approximately 50 μm.

The number of rows of slots can be in a range from 2 rows to 20 rows for a superconductor tape having a 4 mm width. The number of rows can be scaled for the tape width. For example, a 2 mm wide superconductor tape can have 1 row to 5 rows, and an 8 mm wide superconductor tape can have 4 rows to 40 rows.

The shape and dimensions of a slot, which can include depth, width, or both depth and width of the slot can be affected by the cutting tool or technique used in making the slots. The slots can be cut using a laser, a water jet, or the like. Skilled artisans will be able to select a cutting tool and method that meets the needs or desires for a particular application.

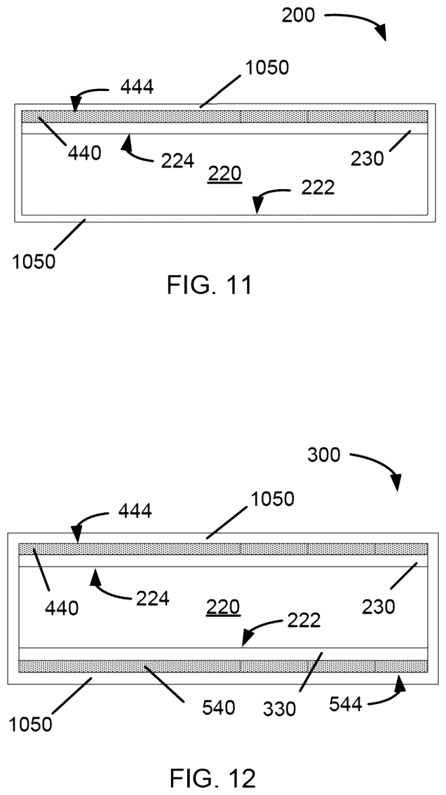

The process includes forming a metal layer along exposed surfaces of the workpiece at block 142 of FIG. 2. FIG. 11 includes a cross-sectional view of the workpiece 200 after forming a metal layer 1050, and FIG. 12 includes a cross-sectional view of the workpiece 300 after forming a metal layer 1050. The metal layer 1050 helps to protect the superconductor film 440. The metal layer 1050 can include Ag or a noble metal, such as Au, Pt, Pd, or the like. The metal layer 1050 has a thickness sufficient to be continuous along the superconductor film 440. In a particular embodiment, the metal layer 1050 is an Ag layer. In the same or different embodiment, the metal layer 1050 can have a thickness of 0.1 micron to 2.0 microns along the horizontal surfaces as illustrate in FIGS. 11 and 12. In FIGS. 11 and 12, the thickness of the metal layer 1050 may be thinner along vertical surfaces of the workpieces 200 and 300, as compared to the horizontal surfaces. In an embodiment, the metal layer 1050 is optional and not used.

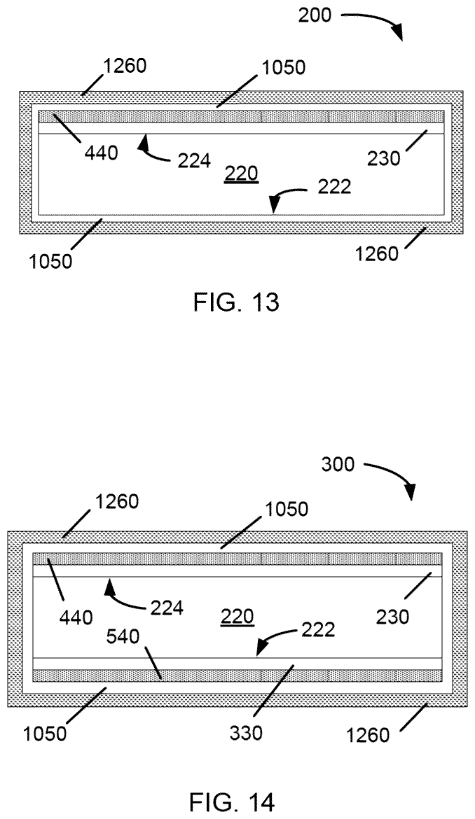

The process includes forming a stabilizer layer along the exposed surfaces of the metal layer at block 144 of FIG. 2. FIG. 13 includes a cross-sectional view of the workpiece 200 after forming a stabilizer layer 1260, and FIG. 14 includes a cross-sectional view of the workpiece 300 after forming a stabilizer layer 1260. The stabilizer layer 1260 can include a material having a resistivity of at most 10 μΩ·cm. An exemplary material includes Cu, Ag, Au, Ni, Al, W, or Zn. The selection of material can affect how the material is deposited. For example, Cu, Ag, Au, and Ni are well suited for plating. When plating, the pH of the plating solution should be selected so that the plated material is not too brittle or too soft. In an embodiment, Cu can be plated using a particular plating solution having a pH in a range from 2.3 to 2.6. The pH may depend on the material being plated and the composition of the plating solution. Empirical data can be collected to determine a desired pH range for a particular plating solution composition and material to be placed. All of the exemplary materials described may be sputter deposited.

Along the horizontal surfaces in FIGS. 13 and 14, the stabilizer layer 1260 can have a thickness in a range from 5 microns to 80 microns. In FIGS. 13 and 14, the thickness of the stabilizer layer 1260 may be thinner along vertical surfaces of the workpieces 200 and 300, as compared to the horizontal surfaces.

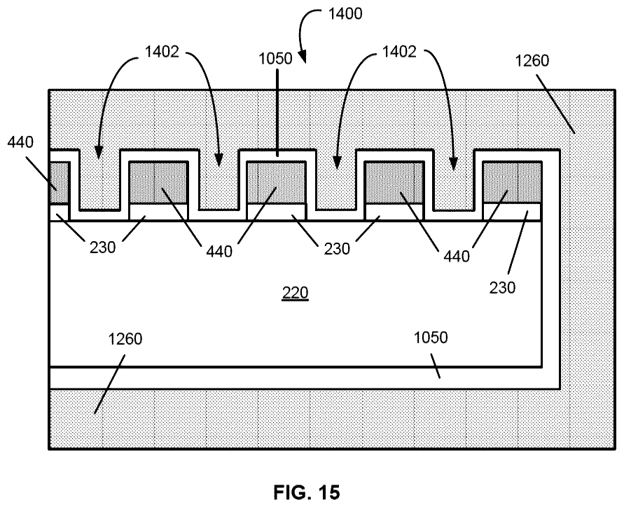

FIG. 15 includes an illustration of a workpiece 1400 that is similar to workpiece 200 in construction. Unlike workpiece 200, the workpiece 1400 has slots 1402 that extend through the superconductor film 440 and buffer layer stack 230. The pattern for the slots 1402 can be any of the slot patterns previously described. The slots 1402 may or may not extend into the substrate 220. The metal layer 1050 makes contact with the substrate 220. If the metal layer 1050 is not used, the stabilizer layer 1260 makes contact with the substrate 220.

The superconductor tapes can be connected together to form a superconductor tape stack. As will be described in more detail below, improved current sharing can help to reduce the adverse effect when a superconductor film of a superconductor tape within the superconductor tape stack has a defect.

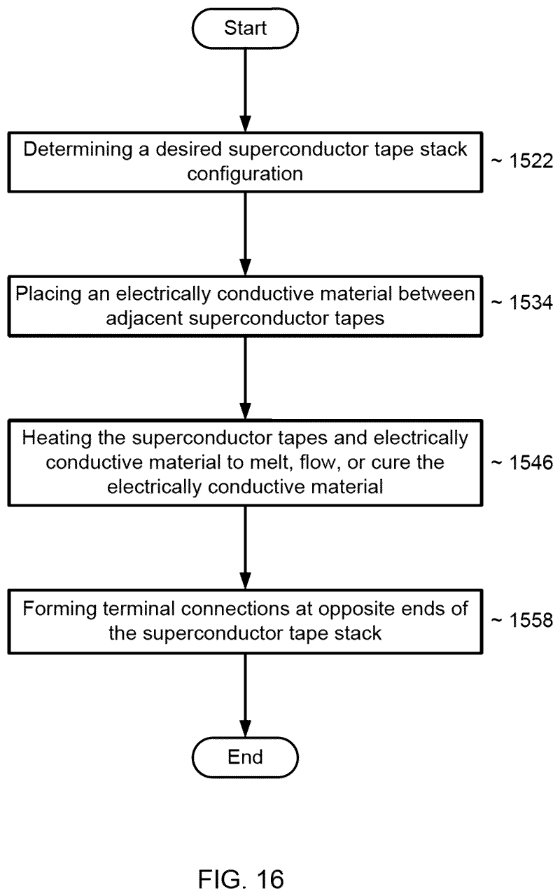

The process of making a superconductor tape stack is described in conjunction with the process flow diagram in FIG. 16. The processing includes determining a desired superconductor tape stack configuration at block 1522 in FIG. 16. A few examples include a superconductor tape stack with a double-sided superconductor tape (2×) configuration, face-to-back (F2B) orientation of superconductor tapes, and face-to-face (F2F) orientation of superconductor tapes. A doubled-sided superconductor tape has superconductor films along opposite sides of the substrate of such tapes.

F2B and F2F configurations use single-sided superconductor tapes, meaning each superconductor tape in the superconductor tape stack has one superconductor film. “Face” refers to the side of the superconductor tape with the superconductor film, and the “back” refers to the opposite side that does not have a superconductor film. For a face-to-back (F2B) configuration, the superconductor film of a superconductor tape is closer to the substrate of a nearest adjacent superconductor tape than to the superconductor film of that nearest adjacent superconductor tape. For a face-to-face (F2F) configuration, the superconductor film of a superconductor tape is closer to the superconductor film of a nearest adjacent superconductor tape than to the substrate of that nearest adjacent superconductor tape.

Each configuration has benefits and challenges. With respect to current sharing, 2X configuration has the best current sharing characteristics, followed by the F2F configuration, and then the F2B configuration. The double-sided superconductor tapes can be more challenging to fabricate. The F2F configuration may not be a good selection for some applications. For example, the F2F configuration is not well suited for use in a magnetic coil, as compared to the 2X configuration and the F2B configuration.

The F2B configuration using conventional single-sided superconductor tapes can have relatively poor current sharing characteristics. The previously described enhancements, such as a substrate with a lower resistivity, a buffer layer stack with lower resistivity, a slot extending through the superconductor film and buffer layer stack and filled with a conductive material, a relatively thinner substrate, a thicker stabilizer layer along the sidewalls of a superconductor tape, or any combination of the enhancements, can improve the current sharing of the F2B configuration. As compared to the F2B configuration with conventional superconductor tapes, the current sharing characteristics for the F2B configuration having a superconductor tape with at least one enhancement is closer to the current sharing characteristics of the 2X configuration. While the enhancements are principally described with respect to the F2B configuration, such enhancements may further improve the current carrying characteristics of a superconductor tape stack having a 2X configuration or a F2F configuration.

Before addressing more details on the superconductor tape stacks, a brief description of connecting tapes is addressed to help to understand better what is meant by a superconductor tape stack. In some applications, two or more superconductor tapes can be serially connected to achieve a desired length that is close to the sum of the lengths of the serially connected individual superconductor tapes. The electrical connection between the two serially connected tapes can be made between two double-sided superconductor tapes or between faces of two single-sided superconductor tapes. For the serial connection, a particular superconductor tape overlaps or underlaps the other superconductor tape by less than 10%, and many times, less than 1% of the length of the particular superconductor tape.

Unlike the serially connected superconductor tapes, for a pair of superconductor tapes in a superconductor tape stack, the superconductor tapes overlap or underlap each other by at least 11% of each of their lengths. Many times, the tapes overlap or underlap each other by at least 50% of each of their lengths or by at least 95% of their lengths. In an embodiment, all superconductor tapes in a superconductor tape stack have substantially the same length. Differences in lengths of superconductor tapes that are to have the same lengths may differ slightly due to manufacturing tolerances.

The process can include placing an electrically conductive material between adjacent superconductor tapes at block 1534 in FIG. 16. Once the superconductor tape stack configuration is determined, electrically conductive material is placed between the superconductor tapes. The electrically conductive material helps to achieve a low contact resistance between the superconductor tapes. The electrically conductive material is used between each pair of superconductor tapes within the superconductor tape stack. The electrically conductive material has a resistivity of at most 35 μΩcm or at most 20 μΩcm. An exemplary material includes In, Sn, a carbon-coated particle or object, graphite, or an alloy that includes In, Sn or Pb, such as Ag-Sn, Ag-Cu-Sn, Pb-Sn, Bi-Sn, Bi-Pb, In-Pb, or In-Ag.

The process can further include heating the superconductor tapes and electrically conductive material to melt, flow, or cure the electrically conductive material at block 1546 in FIG. 16. When any of the superconductor tapes include a REBCO film, the temperature during heating is at most 230° C. to reduce the likelihood of adversely affecting the REBCO film. Many of the electrically conductive materials previously described are solder materials (for example, alloys of In, Sn, or Pb), and such materials can melt or flow at 230° C. or lower. In another embodiment, conductors or other portions of the electrically conductive material may be dispersed within a binder material that can be cured at a temperature of 230° C. or lower. After the superconductor tapes and electrically conductive material are heated, a low resistivity contact between the superconductor tapes can be achieved. As will be described later, in another embodiment, the electrically conductive material may be coated onto or co-wound with a superconductor tape. Thus, heating the superconductor tapes is not required in all embodiments.

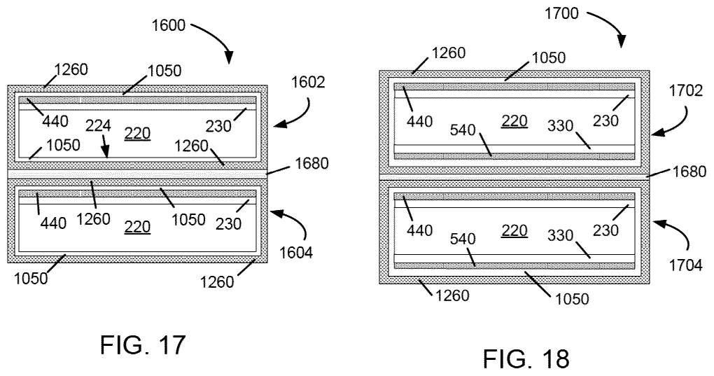

FIGS. 17 and 18 include cross-sectional views of exemplary superconductor tape stacks 1600 and 1700. FIG. 17 illustrates a superconductor tape stack 1600 that includes superconductor tape 1602, a superconductor tape 1604, and an electrically conductive material 1680 that electrically connects the superconductor tapes 1602 and 1604 to each other. FIG. 18 illustrates a superconductor tape stack 1700 that includes superconductor tape 1702, a superconductor tape 1704, and an electrically conductive material 1680 that electrically connects the superconductor tapes 1702 and 1704 to each other. In another embodiment, the superconductor tape stacks 1600 and 1700 can include more than two superconductor tapes. The electrically conductive material 1680 can be disposed between each pair of superconductor tapes.

Referring to FIG. 17, each of the superconductor tapes 1602 and 1604 can include any of the previously described compositions and be formed using any of the processes used to make the superconductor tape that includes the workpiece 200. The superconductor tapes 1602 and 1604 can be identical to each other or may be different from each other. The electrically conductive material 1680 can include any of the electrically conductive materials as previously described with respect to block 1534 in FIG. 16.

In the embodiment illustrated in FIG. 17, the electrically conductive material 1680 extends to the vertical sides of the superconductor tapes 1602 and 1604. Thus, the electrically conductive material 1680 can contact at least 95% of each of the lower surface of the superconductor tape 1602 and the upper surface of the superconductor tape 1604 to the extent the superconductor tape 1602 overlaps the superconductor tape 1604. Less contact area between the electrically conductive material 1680 and the corresponding surfaces of the superconductor tapes 1602 and 1604 may be used if needed or desired. As the contact area decreases, current sharing between the superconductor tapes may decrease. The electrically conductive material 1680 can contact at least 11% of each of the lower surface of the superconductor tape 1602 and the upper surface of the superconductor tape 1604 to the extent the superconductor tape 1602 overlaps the superconductor tape 1604. Simulations can be performed or experimental data can be collected to determine current sharing as a function of contact area between the electrically conductive material 1680 and the corresponding surfaces of the superconductor tapes 1602 and 1604. The contact area between the electrically conductive material and each of the corresponding surfaces of the superconductor tapes 1602 and 1604 can be in a range from 11% to 100%, 30% to 95%, or 50% to 90% to the extent the superconductor tape 1602 overlaps the superconductor tape 1604.

The superconductor tape stack 1600 has a F2B configuration. Each of the superconductor tapes 1602 and 1604 has the buffer layer stack 230 and the superconductor film 440 along the upper surface of the substrate 220 but not along the lower surface. The superconductor tape 1602 does not have a superconductor film along the side 224 of the superconductor tape 1602. Thus, no superconductor film is disposed between the superconductor film 440 of superconductor tape 1604 and the side 224 of the substrate 220.

Referring to FIG. 18, each of the superconductor tapes 1702 and 1704 can include any of the previously described compositions and be formed using any of the processes used to make the superconductor tape that includes the workpiece 300. The superconductor tapes 1702 and 1704 can be identical to each other or may be different from each other. The electrically conductive material 1680 can include any of the electrically conductive materials as previously described with respect to block 1534 in FIG. 16. The contact area between the electrically conductive material 1680 and each of the superconductor tapes 1702 and 1704 can be determined or have any of the values as previously described for the contact area between the electrically conductive material 1680 and each of the superconductor tapes 1602 and 1604.

The superconductor tape stack 1700 has a 2X configuration. Each of the superconductor tapes 1702 and 1704 is a double-sided superconductor tape. The superconductor tapes 1702 and 1704 have the buffer layer stack 230 and the superconductor film 440 along the upper surfaces of the substrate 220 and the buffer layer stack 330 and the superconductor film 540 along the lower surface of the substrate 220.

The process can include forming terminals at opposite ends of the superconductor tape stack at block 1558 in FIG. 16. The terminals allow external power to be connected to the superconductor tape stacks 1600 and 1700.

Superconductor tape stacks described herein allow for current sharing between superconductor tapes within the stacks. A superconductor film of a superconductor tape stack may have a defect. A superconductor tape stack with a 2X configuration can allow current to flow though one or more other superconductor films within the stack.

A superconductor tape stack with a F2B configuration can have one or more superconductor tapes that have any of the previously described enhancements and an electrically conductive material that couples the tapes together. The improved current sharing is better understood with respect to the superconductor tape stack 1600 in FIG. 17. As an example, a superconductor film 440 in the superconductor tape 1602 or 1604 has a defect. Without the electrically conductive material 1680, the superconductor tapes 1602 and 1604 may be electrically connected only at the ends of the tapes, and thus, there is no current sharing between the tapes. The electrically conductive material 1680, particularly if present along most or all of area between the tapes can allow current to flow between the tapes closer to the defect in the superconductor film.

A conventional buffer layer stack can be a dielectric, and thus, little if any current flows through the buffer layer stack. A conductive buffer layer stack as described herein can allow significant current to flow through the buffer layer stack. For the purposes of this specification, a conductive buffer layer stack has a resistivity of at most 1×10⁸ μΩ·cm. A relatively low resistivity substrate described herein can further help with current sharing between superconductor tapes.

Current sharing can be further improved with a slotted buffer layer stack and superconductor film, where the slot is at least partly filled with a conductive material. Each of the metal layer 1050 and the stabilizer layer 1260 has a substantially lower resistivity as compared to the buffer layer stack 230. Thus, current near a defect in the superconductor film can more readily flow from the defective superconductor film 440 to the substrate 220 via the metal layer 1050 and the stabilizer layer 1260 within the slot. If the substrate 220 is more resistive as compared to the metal layer 1050 and the stabilizer layer 1260, deeper slots extending into the substrate 220 can further help with current sharing between the superconductor tapes 1602 and 1604.

While many of the enhancements have been described with respect to the F2B configuration, the enhancements can also be used for the 2X configuration. With respect to the superconductor tape stack in FIG. 18, a defect may be in one of the outer superconductor films (the superconductor film 440 of the superconductor tape 1702 or the superconductor film 540 of the superconductor tape 1704). The conductive buffer layer stack, the relatively low resistivity substrate, slotted superconductor film and buffer layer stack with a conductive metal within a slot, or a combination thereof can help with current flowing from the defective superconductor film to the other superconductor film within the same tape.

The enhancements can also be helpful to a superconductor tape even if the tape is not part of a superconductor tape stack. The relatively low resistivity buffer layer stack, the relatively low resistivity substrate, slotted superconductor film and buffer layer stack having a slot filled with a conductive material, a relatively thinner substrate, a relatively thicker stabilizer layer along sidewalls of the superconductor tapes, or a combination thereof can help with current flowing from the defective superconductor film to the other superconductor film within the same tape. The enhancements can be useful for a single-sided superconductor tape and a double-sided superconductor tape.

The superconductor tape stack with a F2B configuration (for example, the superconductor tape stack 1600) or a 2X configuration (for example, the superconductor tape stack 1700) is very well suited for use in a magnetic coil. The magnetic coils can be used to generate high power density and high magnetic fields for many applications such as fusion, particle accelerators, high-field magnets, energy storage, motors, and generators.

The electrically conductive material between the superconductor tapes in the superconductor tape stacks can be in the form of a layer outside of the stack. The layer can be a coating applied to an exposed surface of a superconductor tape or can be a foil in contact with the superconductor tape. The layer of the electrically conductive material can include a material and a resistivity as previously described with respect to the electrically conductive material 1680. In an embodiment, the electrically conductive material within the layer may be softer than the stabilizer layer of the superconductor tape. For example, superconductor tapes can have stabilizer layers that include plated copper. When the stabilizer layers of the superconductor tapes are to contact each other (no intervening layers), parts of the stabilizer layers will contact each other and other areas will not contact each other due to the topographies along the surfaces of the stabilizer layers. The relatively softer layer of electrically conductive material may conform better to the topographies of the stabilizer layers and improve contact resistance between the superconductor tapes. Exemplary materials for the layer can include conductive particles within a binder or may be a layer or graphene, indium, or the like.

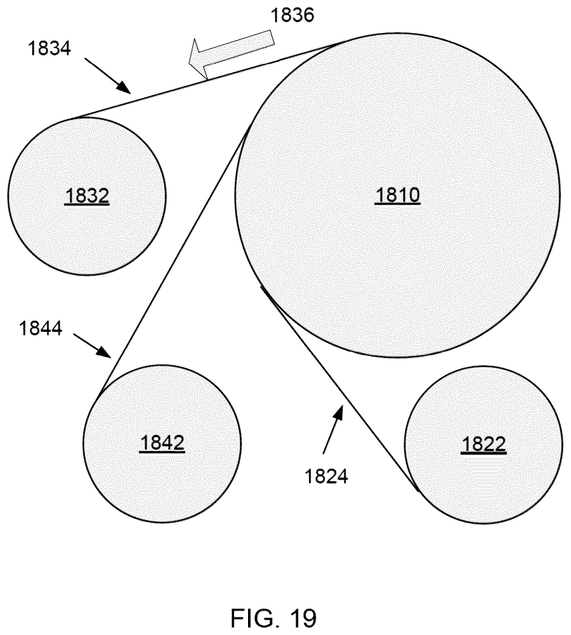

The layer can be used in the formation of a magnetic coil. FIG. 19 includes a magnetic coil 1810 being wound with a superconductor tape 1824 fed by a reel 1822, a superconductor tape 1834 fed by a reel 1832, and a layer 1844 of an electrically conductive material fed by a reel 1842. The magnetic coil can have a core, and superconductor tapes 1824 and 1834 and the layer of electrically conductive material can be part of a winding around the core. The core can include stainless steel, G-10 composite, aluminum, brass, or bronze. The magnetic coil 1810 is rotating in a clockwise direction as the coil is being wound. The layer 1844 becomes disposed between the superconductor tapes 1824 and 1834. While the superconductor tape 1834 is moving from the reel 1832 to the magnetic coil 1810, the superconductor tape 1834 is under tension (the force of which is illustrated by arrow 1836) that helps to apply force onto the layer 1844 during winding. The layer 1844 can be softer than stabilizer layers (not illustrated in FIG. 19) of the superconductor tapes 1824 and 1834. The force applied by the tension helps the relatively softer material within the layer 1844 to conform better to surface roughness, a surface irregularity, or a combination thereof in the superconductor tapes 1824 and 1834 and provide better physical and electrical contact between the superconductor tape 1824 and 1834.

In another embodiment, the superconductor tape 1824 and reel 1822 may not be used. In the same or further embodiment, the layer of electrically conductive material can be in the form of a coating that is applied to the bottom side of the superconductor tape 1834. In the same or different embodiment, the layer or another layer of electrically conductive material can be a coating applied to the top surface (facing the left-hand side of FIG. 19) of the superconductor tape 1824. After reading this specification, skilled artisans will be able to determine which type of layer (coating or foil) is to be used and how it will be introduced into an apparatus based on the needs or desires for a particular application.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. A superconductor tape stack can include a first superconductor tape and a second superconductor tape, wherein the first superconductor tape and the second superconductor tape are arranged in a face-to-back configuration within the superconductor tape stack, and the superconductor tape stack has a contact resistivity of at most 700 nΩcm².

Embodiment 2. The superconductor tape stack of Embodiment 1, wherein each of the first superconductor tape and the second superconductor tape includes a substrate.

Embodiment 3. A superconductor tape stack can include a first superconductor tape and a second superconductor tape, wherein each of the first superconductor tape and the second superconductor tape includes a substrate and a superconductor film adjacent to the substrate, the first superconductor tape and the second superconductor tape are arranged in a face-to-back configuration within the superconductor tape stack, and the substrate of the first superconductor tape, the second superconductor tape, or each of the first superconductor tape and the second superconductor tape has a resistivity of at most 50 μΩcm.

Embodiment 4. The superconductor tape stack of Embodiment 2 or 3, wherein each of the first superconductor tape and the second superconductor tape includes a buffer layer stack disposed along a side of the substrate.

Embodiment 5. A superconductor tape stack can include a first superconductor tape and a second superconductor tape, wherein each of the first superconductor tape and the second superconductor tape includes a substrate and a buffer layer stack along a side of the substrate, the first superconductor tape and the second superconductor tape are arranged in a face-to-back configuration within the superconductor tape stack, and the buffer layer stack of the first superconductor tape, the second superconductor tape, or each of the first superconductor tape and the second superconductor tape has a resistivity of at most 1×10⁸ μΩcm.

Embodiment 6. The superconductor tape stack of Embodiment 4 or 5, wherein each of the first superconductor tape and the second superconductor tape includes a REBCO film, wherein the buffer layer stack disposed between the substrate and the REBCO film.

Embodiment 7. The superconductor tape stack of Embodiment 6, wherein a first slot extends through the REBCO film and the buffer layer stack of the first superconductor tape, the second superconductor tape, or each of the first superconductor tape and the second superconductor tape, a conductive material at least partly fills the first slot, wherein the conductive material has a resistivity at most 1 mΩcm, and a critical current of the first superconductor tape, the second superconductor tape, or each of the first superconductor tape and the second superconductor tape having the first slot is at least 80 A/4 mm width at 77 K, 0 T.

Embodiment 8. A superconductor tape stack can include a first superconductor tape and a second superconductor tape, wherein each of the first superconductor tape and the second superconductor tape includes a buffer layer stack and a REBCO film, and the first superconductor tape and the second superconductor tape are arranged in a face-to-back configuration within the superconductor tape stack, a first slot extends through a REBCO film and a buffer layer stack of the first superconductor tape, the second superconductor tape, or each of the first superconductor tape and the second superconductor tape, a conductive material at least partly fills the first slot, wherein the conductive material has a resistivity less than 1 mΩcm, and a critical current of the first superconductor tape, the second superconductor tape, or each of the first superconductor tape and the second superconductor tape having the slot is at least 80 A/4 mm width at 77 K, 0 T.

Embodiment 9. The superconductor tape stack of Embodiment 8, wherein each of the first superconductor tape and the second superconductor tape includes a substrate, and wherein the buffer layer stack is disposed between the substrate and the REBCO film.

Embodiment 10. The superconductor tape stack of Embodiment 8 or 9, wherein the first superconductor tape, the second superconductor tape, or each of the first superconductor tape and the second superconductor tape has a substrate.

Embodiment 11. The superconductor tape stack of any one of Embodiments 7 to 10, wherein a width of the first slot is in a range from 5 μm to 200 μm.

Embodiment 12. The superconductor tape stack of any one of Embodiments 7 to 11, wherein the first superconductor tape, the second superconductor tape, or each of the first superconductor tape and the second superconductor tape has a plurality of slots including the first slot, and a number of slots in the plurality of slots is in a range from 2 to 20 over a tape width of 4 mm.

Embodiment 13. The superconductor tape stack of any one of Embodiments 7 to 12, wherein the REBCO film of the first superconductor tape, the second superconductor tape, or each of the first superconductor tape and the second superconductor tape includes RE₁Ba₂Cu₃O_{7-δ}, where RE is Y, Gd, Sm, Nd, Eu, Dy, Ho, Yb, Er, Tm, Lu, or a combination thereof, and 0.0≤δ≤0.5.

Embodiment 14. The superconductor tape stack of any one of Embodiments 4 to 13, wherein the buffer layer stack has a resistivity in a range from 4 μΩcm to 1×10⁸ μΩcm .

Embodiment 15. The superconductor tape stack of any one of Embodiments 4 to 14, wherein the buffer layer stack includes TiN, LaNiO₃, SrVO₃, SrRuO₃, Nb-doped SrTiO₃, or a combination thereof.

Embodiment 16. A superconductor tape stack can include a first superconductor tape and a second superconductor tape. The first superconductor tape, the second superconductor tape, or each of the first superconductor tape and the second superconductor tape can include a substrate having a first side and a second side opposite the first side; a first REBCO film along the first of the substrate; and a second REBCO film along the second side of the substrate. Each of the first superconductor tape and the second superconductor tape has a length, at least 11% of the length of the first superconductor tape overlaps the second superconductor tape, and at least 11% of the length of the second superconductor tape is overlapped by the first superconductor tape.

Embodiment 17. The superconductor tape stack of Embodiment 16, wherein the contact resistivity of the superconductor tape stack is in a range from 5 nΩcm² to 700 nΩcm².

Embodiment 18. The superconductor tape stack of Embodiment 16 or 17, wherein each of the first superconductor tape and the second superconductor tape further includes a first buffer layer stack disposed between the substrate and the first REBCO film; and a second buffer layer stack disposed between the substrate and the second REBCO film.

Embodiment 19. The superconductor tape stack of Embodiment 18, wherein: a first slot extends through (1) the first REBCO film and the first buffer layer stack of the first superconductor tape, the second superconductor tape, or each of the first superconductor tape and the second superconductor tape, (2) the second REBCO film and the second buffer layer stack of the first superconductor tape, the second superconductor tape, or each of the first superconductor tape and the second superconductor tape, or each of (1) and (2). A conductive material can at least partly fill the first slot, wherein the conductive material has a resistivity less than 1 mΩcm, and a critical current of the first superconductor tape, the second superconductor tape, or each of the first superconductor tape and the second superconductor tape having the first slot can be at least 80 A/4 mm width at 77 K, 0 T.

Embodiment 20. The superconductor tape stack of Embodiment 19, wherein a width of the first slot is in a range from 5 μm to 200 μm.

Embodiment 21. The superconductor tape stack of Embodiment 19 or 20, wherein a plurality of slots including the first slot extends through (1) the first REBCO film and the first buffer layer stack of the first superconductor tape, the second superconductor tape, or each of the first superconductor tape and the second superconductor tape, (2) the second REBCO film and the second buffer layer stack of the first superconductor tape, the second superconductor tape, or each of the first superconductor tape and the second superconductor tape, or each of (1) and (2), and a number of slots in the plurality of slots is in a range from 2 to 20 over a tape width of 4 mm.

Embodiment 22. The superconductor tape stack of any one of Embodiments 18 to 21, wherein the first buffer layer stack, the second buffer layer stack, or each of the first buffer layer stack and the second buffer layer stack includes TiN, LaNiO₃, SrVO₃, SrRuO₃, or Nb-doped SrTiO₃, or a combination thereof.

Embodiment 23. The superconductor tape stack of any one of Embodiments 16 to 22, wherein the first REBCO film, the second REBCO film, or each of the first REBCO film and the second REBCO film includes RE₁Ba₂Cu₃O_{7-δ}, where RE is Y, Gd, Sm, Nd, Eu, Dy, Ho, Yb, Er, Tm, Lu, or a combination thereof, and 0.0≤δ≤0.5.

Embodiment 24. The superconductor tape stack of any one of Embodiments 2 to 7 and to 23, wherein the substrate of the first superconductor tape, the second superconductor tape, or each of the first superconductor tape and the second superconductor tape has a resistivity in a range from 2 μΩcm to 50 μΩcm.

Embodiment 25. The superconductor tape stack of any one of Embodiments 2 to 7 and to 24, wherein the substrate of the first superconductor tape, the second superconductor tape, or each of the first superconductor tape and the second superconductor tape has a thickness in a range from 10 μm to 100 μm.

Embodiment 26. The superconductor tape stack of any one of Embodiments 2 to 7 and to 25, wherein the substrate of the first superconductor tape, the second superconductor tape, or each of the first superconductor tape and the second superconductor tape has a yield strength of at least 300 MPa.

Embodiment 27. The superconductor tape stack of any one of Embodiments 2 to 7 and to 26, wherein the substrate of the first superconductor tape, the second superconductor tape, or each of the first superconductor tape and the second superconductor tape includes Cu and W, wherein the substrate has 20 wt. % Cu to 70 wt. % Cu and 30 wt. % W to 80 wt. % W.

Embodiment 28. The superconductor tape stack of any one of Embodiments 1 to 27 further includes an electrically conductive material disposed between the first superconductor tape and the second superconductor tape, wherein the electrically conductive material has a resistivity of at most 35 μΩcm.

Embodiment 29. The superconductor tape stack of Embodiment 28, wherein the electrically conductive material has a melting point temperature, a flow point temperature, a cure temperature of at most 230° C.

Embodiment 30. A magnetic coil can include the superconductor tape stack of any one of Embodiments 1 to 29, wherein the superconductor tape stack is at least part of a winding of the magnetic coil.

Embodiment 31. A method of making the superconductor tape stack of any one of Embodiments 1 to 29.

Embodiment 32. A superconductor tape can include a substrate having a first side and a second side opposite the first side, wherein the substrate has a resistivity of at most 50 μΩcm; and a first superconductor film that is closer to the first side of the substrate than to the second side of the substrate.

Embodiment 33. A superconductor tape can include a substrate having a first side and a second side opposite the first side; a first superconductor film that is closer to the first side of the substrate as compared to the second side of the substrate; a stabilizer layer, wherein the first superconductor film is disposed between the substrate and the stabilizer layer; and a layer of an electrically conductive material. The stabilizer layer can be disposed between the first superconductor film and the layer of the electrically conductive material, and the electrically conductive material can be softer than the stabilizer layer.

Embodiment 34. The superconductor tape of Embodiment 32 or 33 further includes a first buffer layer stack disposed between the substate and the superconductor film.

Embodiment 35. A superconductor tape can include a substrate having a first side and a second side opposite the first side; a first buffer layer stack along the first side of the substrate, wherein the first buffer layer stack has a resistivity of at most 1×10⁸ μΩcm; and a first superconductor film, wherein the first buffer layer stack is disposed between the substrate and the first superconductor film.

Embodiment 36. A superconductor tape can include a substrate having a first side and a second side opposite the first side; a first buffer layer stack along the first side of the substrate; and a first superconductor film, wherein the first buffer layer stack is disposed between the substrate and the first superconductor film. The superconductor tape can have a first slot that extends through the first superconductor film and the first buffer layer stack, and a conductive material can at least partly fill the first slot and can have a resistivity at most 1 mΩcm.

Embodiment 37. The superconductor tape of any one of Embodiments 33 to 36, wherein the substrate has a resistivity of at most 50 μΩcm.

Embodiment 38. The superconductor tape of any one of Embodiments 32 and 34 to 36 further includes a stabilizer layer, wherein the first superconductor film is disposed between the substrate and the stabilizer layer; and a layer of an electrically conductive material. The stabilizer layer can be disposed between the first superconductor film and the layer of the electrically conductive material, and the electrically conductive material can be softer than the stabilizer layer.

Embodiment 39. The superconductor tape of any one of Embodiments 32 to 34 and 36, wherein the first buffer layer stack has a resistivity of at most 1×10⁸ μΩcm.

Embodiment 40. The superconductor tape of any one of Embodiments 32 to 35, wherein the superconductor tape has a slot that extends through the first superconductor film and the first buffer layer stack, and a conductive material at least partly fills the slot and has a resistivity at most 1 mΩcm.

Embodiment 41. The superconductor tape of any one of Embodiments 32 to 40, wherein the superconductor tape is a single-sided superconductor tape.

Embodiment 42. The superconductor tape of any one of Embodiments 34 to 40 further includes a second buffer layer stack along the second side of the substrate; and a second superconductor film, wherein the second buffer layer stack is disposed between the substrate and the second superconductive film.

Embodiment 43. The superconductor tape of Embodiment 42, wherein the second buffer layer stack has a resistivity of at most 1×10⁸ μΩcm.

Embodiment 44. The superconductor tape of Embodiment 42 or 43, wherein the superconductor tape has a second slot that extends through the second superconductor film and the second buffer layer stack, and a conductive material at least partly fills the second slot and has a resistivity at most 1 mΩcm.

Embodiment 45. The superconductor tape of any one of Embodiments 32 to 40, 41, and 42, wherein the superconductor tape is a double-sided superconductor tape.

Embodiment 46. A magnetic coil can include the superconductor tape of any one of Embodiments 32 to 45, wherein the superconductor tape is at least part of a winding of the magnetic coil.

Embodiment 47. A method of making the superconductor tape of any one of Embodiments 32 to 45.

### EXAMPLES

Examples described below are provided to demonstrate current sharing between superconductor tapes within superconductor tape stacks when a superconductor film within the superconductor tape stack has a defect. The examples are to aid in the understanding of the concepts described herein and not to limit the scope of the invention as defined in the appended claims.

In the examples below, unless explicitly stated to the contrary, the substrates are made of a Hastelloy®-brand alloy having a resistivity of 124 μΩ·cm and a thickness of 50 μm, the buffer layer stacks are made of amorphous Al₂O₃ /Y₂O₃/IBAD MgO/Y₂O₃/homo-epitaxial MgO/LaMnO₃ having a resistivity of approximately 1×10²⁰ μΩ·cm, the superconductor films are REBCO films, and neither the superconductor films nor the buffer layer stacks are slotted. In the examples, the REBCO films have substantially the same metal oxides and their corresponding contents, the metal layer is a silver layer, and the stabilizer layer is a copper layer. Within the superconductor tape stacks, the superconductor tapes are soldered together with an electrically conductive material that is a metal alloy having a melting or flow point of at most 230 C. Each superconductor tape within the stack is to reach I_{c} of at least 80 A, at least 100 A, or at 150 A along the entire length of the tape between the super conductor tape stack terminals for the superconductor tape stack. In order to accommodate a short-term over-current situation when the stack is in use, each superconductor tape within the stack may have an I_{c} of at least 84 A, at least 105 A, or at 155 A along the entire length of the tape between the super conductor tape stack terminals for the superconductor tape stack.

For contact resistivity measurements, the pair of voltage taps are separated by an approximately 8 cm distance.

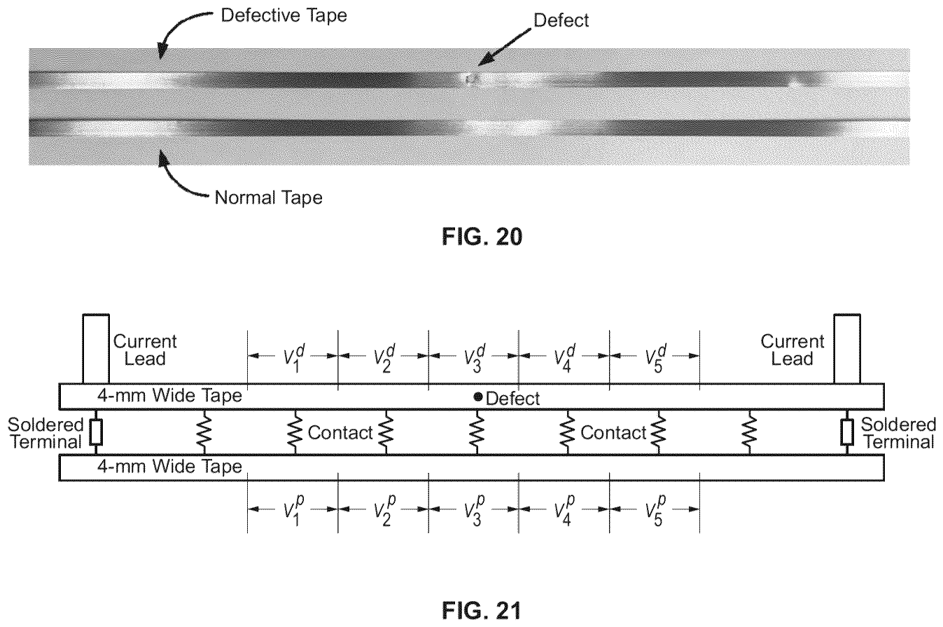

In the examples, the superconductor tape stacks included two superconductor tapes with widths of approximately 4 mm and lengths of approximately 25 cm. FIG. 20 includes an image of superconductor tapes that are used in the examples. A defect was introduced into one of the tapes by removing some of a superconductor film to define an opening approximately 2 mm in diameter. For a single-sided tape, the defect can be introduced by punching a hole in the tape. For a double-sided tape, the defect can be introduced by removing a 2 mm diameter portion of a superconductor film along one side of the tape while leaving the other superconductor film along the opposite side of the tape unaffected.

The superconductor tape stacks correspond to the superconductor tape stack 1600 in FIG. 17 when single-sided superconductor tapes are used, and the superconductor tape stacks correspond to the superconductor tape stack 1700 in FIG. 18 when double-sided superconductor tapes are used. Within a superconductor tape stack, a superconductor tape with the defect can be referred to as a “defective tape,” and a superconductor tape without an intentional defect can be referred to as a “normal tape.” Slots, if any, may be present where explicitly described but are not illustrated in FIGS. 17 and 18; however, FIG. 15 includes an illustration of the workpiece 1400 that is a portion of a superconductor tape that has slots 1402.

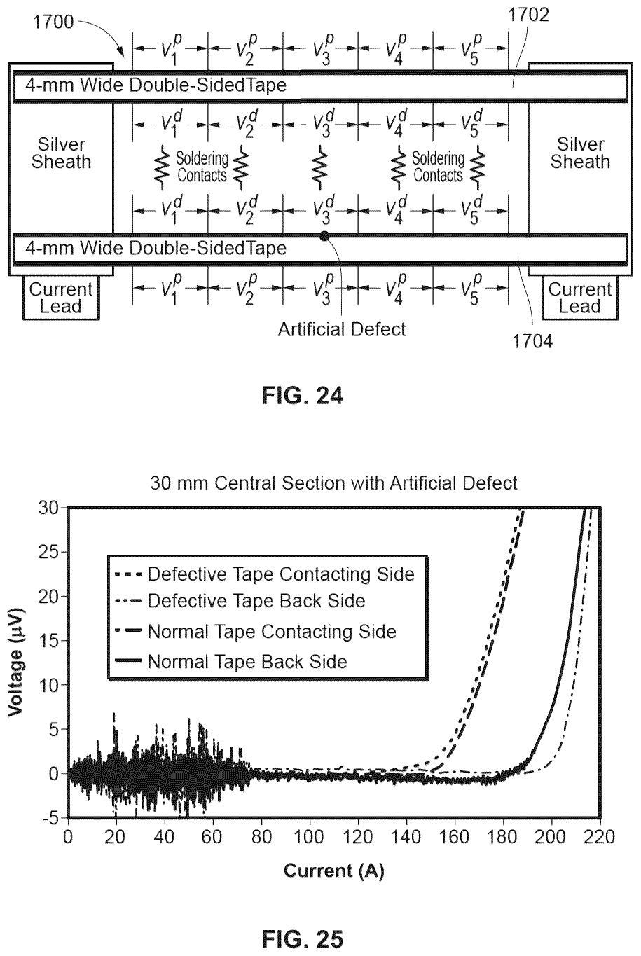

Referring to the circuit representations in FIGS. 21 and 24, each of the normal superconductor tapes include Sections P-1, P-2, P-3, P-4, and P-5 that correspond to V^{P}₁, V^{P}₂, V^{P}₃, V^{P}₄, and V^{P}₅, respectively. Each of the defective superconductor tapes include Sections D-1, D-2, D-3, D-4, and D-5 that correspond to V^{d}₁, V^{d}₂, V^{d}₃, V^{d}₄, and V^{d}₅, respectively. For a double-sided tape, a normal superconductor tape has Sections D-1, D-2, D-3, D-4, and D-5 along the side of the normal tape, where the side is closer to the defective tape, and a defective superconductor tape has Sections P-1, P-2, P-3, P-4, and P-5 along the side of the defective tape, where the side is opposite the defect.

Each of the sections has a length of approximately 30 mm and a width of 4 mm. Each of the voltages is the voltage differences between the ends of the sections as measured in the length direction of the superconductor tapes.

In the examples below, Examples 1 to 3 are based on experimental data, and Examples 4 to 57 are based on simulations.

### Example 1—F2B Configuration

Example 1 demonstrates that current sharing may be insufficient with a particular superconductor tape stack having a F2B configuration. The superconductor tape stack used for Example 1 had a F2B configuration and a construction that is illustrated as the superconductor tape stack 1600 in FIG. 17. FIG. 21 includes an electrical circuit representation of the superconductor tape stack in Example 1 and other examples described below that have a F2B configuration. Referring to FIGS. 17 and 21, contact between the electrically conductive material 1680 and each of the superconductor tapes 1602 and 1604 are represented by resistors between the tapes.

Current leads (that are a type of terminals for the superconductor tape stack) were at the ends of the superconductor tape stack. Six voltage taps are placed along each of the superconductor tapes. Referring to FIGS. 17 and 21, the defect was in Section 3-D of the defective superconductor tape. The defect was where a 2 mm diameter portion of the superconductor film 440 in the superconductor tape 1602 is removed.

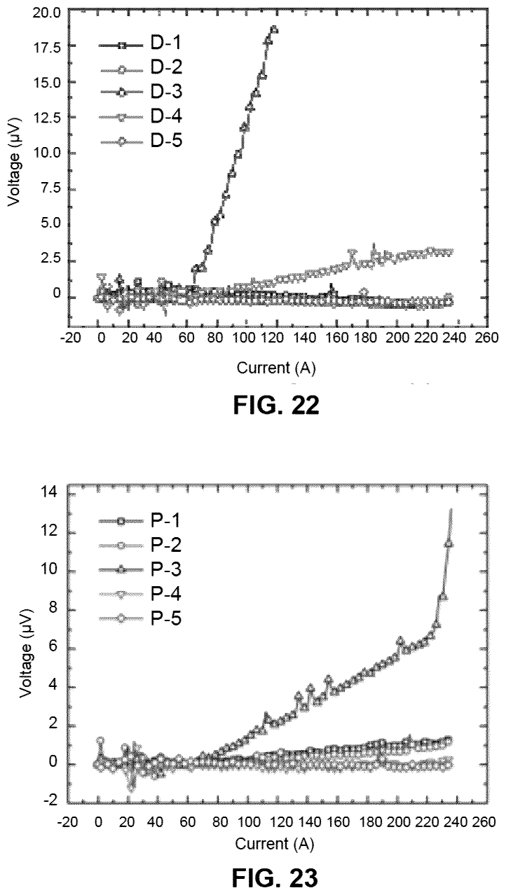

FIG. 22 includes I-V curves for each of the Sections of the defective superconductor tape, and FIG. 23 includes I-V curves for each of the Sections of the normal superconductor tape. Other than Sections D-3 and P-3 of the tapes, the other sections reached a current of at least 155 A at section voltages less than 2.5 μV. As observed in FIGS. 22 and 23, current sharing between the tapes 1602 and 1604 occurs, localized around the defective section D-3. However, a substantially high voltage response occurred with the defective Section D-3, starting at a relatively low current of 60 A (FIG. 22). A voltage response in the normal Section P-3 starting at 60 A was observed in the normal tape as well (FIG. 23). Thus, a higher energy dissipation occurred, starting at a low current value during current transfer from the defective tape. Such high energy dissipation can pose a threat of uncontrolled quench and damage. Example 1 is not well suited for an application that needs to support a current of at least 80 A.

### Example 2—2X Configuration

Example 2 demonstrates that a superconductor tape stack in a 2X configuration has very good current sharing characteristics.

The superconductor tape stack used for Example 2 had a 2X configuration and corresponds to the superconductor tape stack 1700 in FIG. 18. FIG. 24 includes an electrical circuit representation of Example 1. Referring to FIGS. 18 and 24, contact between the electrically conductive material 1680 and each of the superconductor tapes 1702 and 1704 are represented by resistors between the tapes. Current leads (that are a type of terminals for the superconductor tape stack) are at the ends of the superconductor tape stack. Six voltage taps are placed along each side of the superconductor tapes.

The defect as illustrated in FIG. 24 was within Section D-3 in the defective tape. The other sections within the defective tape did not have any intentional defects. Referring to FIG. 18, the defect was located in the superconductor film 440 of the superconductor tape 1704. Thus, the defect was along the side of the superconductor tape 1704 that contacts the electrically conductive material 1680, and such side is referred to as the contacting side. The opposite side is referred to as the back side.

FIG. 25 includes current-voltage (I-V) curves obtained from Section 3-P and 3-D of the normal tape and Sections 3-P and 3-D of the defective tape within the superconductor tape stack. For all of the Section 3s, currents reached at least approximately the desired I_{c} of 155 A at voltages (V^{d}₃ and V^{P}₃ for each of the tapes) of no greater than 2.5 μV. The current was well shared between two contacting surfaces of the defective tape (superconductor tape 1704) and normal tape (superconductor tape 1702), even though, the defective tape by itself (when not part of a superconductor tape stack) had a much lower current-carrying capacity due to the artificial defect. This good current sharing is due to the low face-to-face contact resistivity between two double-sided superconductor tapes.

### Example 3—F2B Configuration with Slotted Tapes

Example 3 demonstrates that more current sharing between superconductor tapes within a superconductor tape stack when the superconductor tapes are slotted.

The superconductor tape stack used for Example 3 has a F2B configuration and a construction that is illustrated as the superconductor tape stack 1600 in FIG. 17. The superconductor tapes in Example 3 were substantially the same as in Example 1 except that slotted single-sided superconductor tapes (see workpiece 1400 in FIG. 15) were used. The slots had a pattern as illustrated with the top tape 620 in FIG. 7. Each of the superconductor tapes had 11 rows of slots, where the rows had a pitch of approximately 1.0 mm. Along each row, the slot pitch was approximately 2.0 mm with approximately 1.3 mm slots and 0.7 mm spaces. Each of the slots was approximately 10 μm deep. Referring to FIGS. 17 and 21, the defect was in Section 3-D of the defective superconductor tape. The defect was a 2 mm diameter portion of the superconductor film 440 in the superconductor tape 1602 was removed.

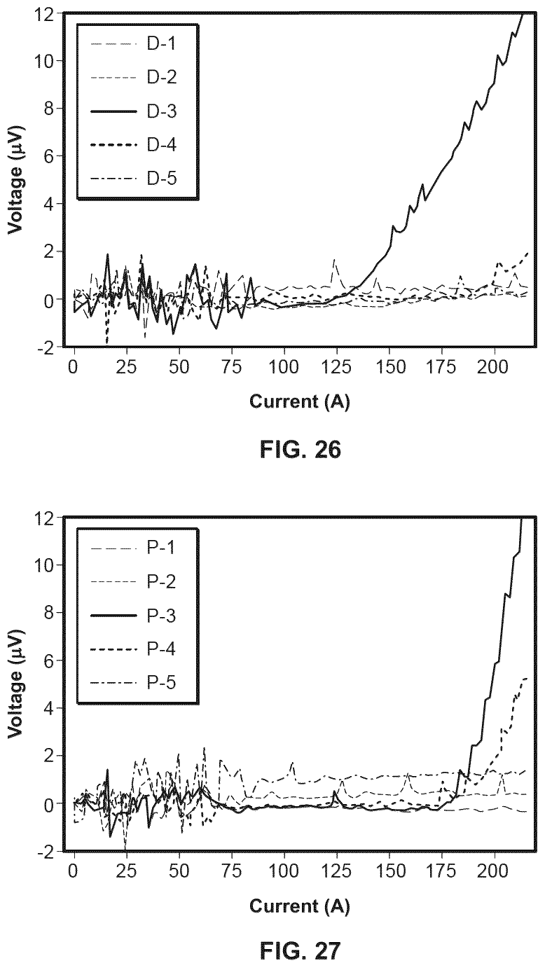

FIG. 26 includes I-V curves for each of the sections of the defective superconductor tape, and FIG. 27 includes I-V curves for each of the sections of the normal superconductor tape. The section D-3 of the defective tape reached its critical current transition criterion of 2.5 μV at a current of 155 A, which is substantially higher than value of 70 A seen in FIG. 21 where the defective tape is not slotted. This result shows that better current sharing occurred when the superconductor tapes are slotted. When voltage at Section P-3, which is in parallel with defective section D-3, reached its transition criterion of 2.5 μV the current was approximately 190 A. Most other sections of the normal superconductor tape demonstrate hardly any voltage difference across the sections, indicating the current sharing occurred locally around Section P-3 in the normal superconductor tape. Thus, Example 3 highlights the effectiveness of the slotting strategy to improve current sharing.

### Examples 4 to 7—Comparison of Different Tape Architectures on Contact Resistivity

Examples 4 to 7 demonstrate that contact resistivity can be affected by the construction of the superconductor tapes that make up the superconductor tape stack. Example 4 has a superconductor tape stack construction that is described in Example 1 (F2B configuration), Example 5 has a superconductor tape stack construction that is described in Example 2 (2X configuration, dielectric buffer layer stack, no slots), Example 6 has a superconductor tape stack construction that is described in Example 3 (F2B configuration, dielectric buffer layer stack, has slots). Example 7 has a superconductor tape construction similar to Example 1 except that a conductive buffer layer stack replaces the dielectric buffer layer stack.

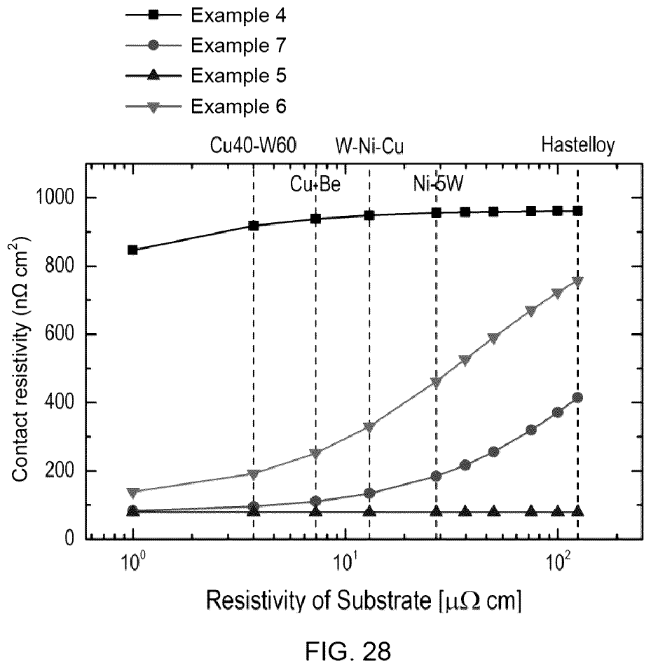

FIG. 28 includes a plot of contact resistivity for the superconductor tape stacks as a function of the resistivity of the substrate used in the stacks. The plots include resistivities for some materials that can be used for the substrates, and such materials include a Hastelloy®-brand alloy, Ni-5W, W-Ni-Cu, a Berylco®-brand alloy, and Cu40-W60. The table below lists substrate materials and their corresponding resistivities. Not all of the substrate materials listed below are identified in FIG. 28.

| Substrate | |
|---|---|
| resistivity (nΩ · cm) | Material |
| 124 | Hastelloy ®-brand alloy |
| 57 | SUS 316 |
| 37 | Monel ®-brand alloy |
| 29 | Ni—5W |
| 10 | W—Ni—Cu |
| 7.3 | Berylco ®-brand alloy |
| 6.5 | Cu10—W90 |
| 4.0 | Cu40—W60 |
| 3.4 | Cu50—W50 |

In the table, SUS 316 is stainless steel 316, Ni-5W has 95 at.% Ni and 5 at.% W, W-Ni-Cu has 97 at.% W, 2.1 at.% Ni, and 5 at.% Cu, Cu-10-W90 has 10 wt. % Cu and 90 wt. % W, Cu40-W60 has 40 wt. % Cu and 60 wt. % W, and Cu50-W50 has 50 wt. % Cu and 50 wt. % W. For the Cu-W alloys or composites, the W content can be listed before the Cu content. Thus, Cu10-W90 is the same as W90-Cu10.

Example 4 demonstrates that the contact resistivity can be lowered when resistivity of the substrate decreases; however, the contact resistivity remains relatively high (over 800 nΩ·cm²). Example 5 demonstrates that for the 2X configuration, contact resistivity remains relatively low (less than 100 nΩ·cm²) and substantially constant as the resistivity of the substrate changes. Thus, the resistivity of the substrate does not have a significant effect on the contact resistivity for a 2X configuration.

Example 6 demonstrates that slots can help to reduce significantly contact resistivity as the resistivity of the substrate decreases. The superconductor tapes for Example 6 have 8 continuous slots (see bottom tape 660 in FIG. 7 for reference), each being 50 μm wide and 50 μm deep. The slots reduce I_{c} by approximately 10%; however, lower resistivity substrates can allow the contact resistivity in an F2B configuration to be as low as approximately 1.5 times the contact resistivity for the 2X configuration. Referring to the Example 6 plot in FIG. 28, the contact resistivity is less than 800 nΩ·cm² for Hastelloy®-brand alloy substrates (resistivity of 124 μΩ·cm), and the contact resistivity is less than 400 nΩ·cm² for W-Ni-Cu substrates (resistivity of 13 μΩ·cm). The contact resistivity greatly decreases to approximately 180 μΩ·cm² for Cu40-W60 substrates (resistivity of 4 μΩ·cm), and the contact resistivity is approximately 150 nΩ·cm2 for substrates having a resistivity of 1 μΩ·cm.

Example 7 demonstrates that a conductive buffer layer stack can help to reduce significantly contact resistivity as the resistivity of the substrate decreases. In Example, TiN_{0.8} (having a resistivity of approximately 4.2 μΩ·cm) replaced each of the Al₂O₃ and MgO within the buffer layer stack. The data for Example 7 is better than the data for Example 6. The contact resistivity is approximately 400 nΩ·cm2 for Hastelloy®-brand alloy substrates (resistivity of 124 μΩ·cm), and the contact resistivity is less than 180 nΩ·cm2 for Ni-5W substrates (resistivity of 29 μΩ·cm). The contact resistivity is approximately 100 nΩ·cm2 for Cu40-W60 substrates (resistivity of 4 μΩ·cm). The contact resistivity is approximately 90 nΩ·cm2 for substrates having a resistivity of 1 μΩ·cm, which is about the same contact resistivity of the superconductor tape stack having the 2X configuration (Example 5).

Thus, Examples 4 to 7 demonstrate that the superconductor tape stacks with a F2B configuration can have contact resistivities that are relatively closer to the contact resistivity achieved by a superconductor tape stack having a 2X configuration when the superconductor tape stack with the F2B configuration has the superconductor tapes with (1) substrates having a relatively low resistivity and (2) (i) slots extending through the superconductor film and a buffer layer stack where the slots are filled with a conductive material or (ii) replacing a dielectric buffer layer with a conductive buffer layer stack. A superconductor tape stack with a F2B configuration where the superconductor tapes have relatively low resistivity substrates, slots filled with conductive material, and conductive buffer layers may have lower contact resistivity as compared to the other superconductor tape stacks with a F2B configuration.

### Examples 8 to 11—Different Thicknesses of Substrates

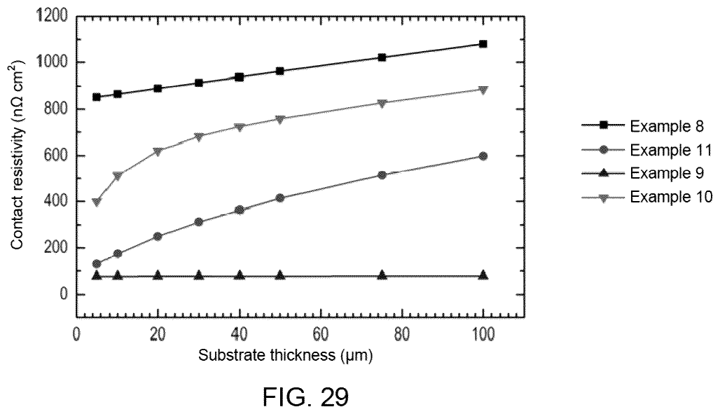

Examples 8 to 11 demonstrate the change in contact resistivity as a function of the thickness of a substrate. The construction of Examples 8 to 11 is similar to Examples 4 to 7, respectively; however, all substrates in Examples 8 to 11 are made of a Hastelloy®-brand alloy. The superconductor tape stack in Example 8 has the same construction as the superconductor tape stack in Example 4 except that the superconductor tape stack in Example 8 has different thicknesses for the substrates. Referring to FIG. 29, Example 8 demonstrates that the contact resistivity can be lowered when thicknesses of the substrates decrease; however, the contact resistivity remains relatively high (over 800 nΩ·cm²).

Just like Example 5, the superconductor tape stack in Example 9 has a 2X configuration. Referring to FIG. 29, Example 9 demonstrates that for the 2X configuration, contact resistivity remains relatively low (less than 100 nΩ·cm²) and substantially constant as the thickness of the substrate changes.

The superconductor tape stack in Example 10 has the same construction as the superconductor tape stack in Example 6 except that the superconductor tape stack in Example 10 has different thicknesses for the substrates. Example 10 demonstrates that slots can help to reduce significantly contact resistivity as the thickness of the substrate decreases. Referring to FIG. 29, the contact resistivity is approximately 800 nΩ·cm² for a thickness of 75 μm. The contact resistivity starts to exponentially drop after the thicknesses of the substrates are below 30 μm, and the contact resistivity is approximately 400 nΩ·cm² for a substrate having a thickness of 4 μm.

The superconductor tape stack in Example 11 has the same construction as the superconductor tape stack in Example 7 except that the superconductor tape stack in Example 11 has different thicknesses for the substrates. Example 11 demonstrates that a conductive buffer layer stack can help to reduce significantly contact resistivity as the resistivity of the substrate decreases. The data for Example 11 is better than the data for Example 10. The contact resistivity is approximately 600 nΩ·cm² for a substrate thickness of 100 μm, and the contact resistivity is less than 130 nΩ·cm² for a substrate thickness of 4 μm.

Similar to Examples 4 to 7, in Examples 8 to 11, the best electrical performance occurs with a superconductor tape stack having a 2X configuration. Enhancements, such as slots or a conductive buffer layer stack, can help a superconductor tape stack having an F2B configuration to have electrical performance closer to a superconductor tape stack having a 2X configuration.

### Examples 12 to 14—Different Number of Slots

Examples 12 to 14 demonstrate the change in contact resistivity as a function of the number of slots within superconductor tapes. Each slot extends through the superconductor film and dielectric buffer layer and has a depth of approximately 10 μm and a width of approximately 50 μm wide.

The superconductor tape stack in Example 12 has the same construction as the superconductor tape stack in Example 4 except that the superconductor tape stack in Example 12 has superconductor tapes that have slots cut through the superconductor film and buffer layer stack and the slots are filled with a silver metal layer and a copper stabilizer layer. Example 12 demonstrates that the contact resistivity can be lowered when number of slots increases; however, the contact resistivity remains relatively high (over 600 nΩ·cm²).

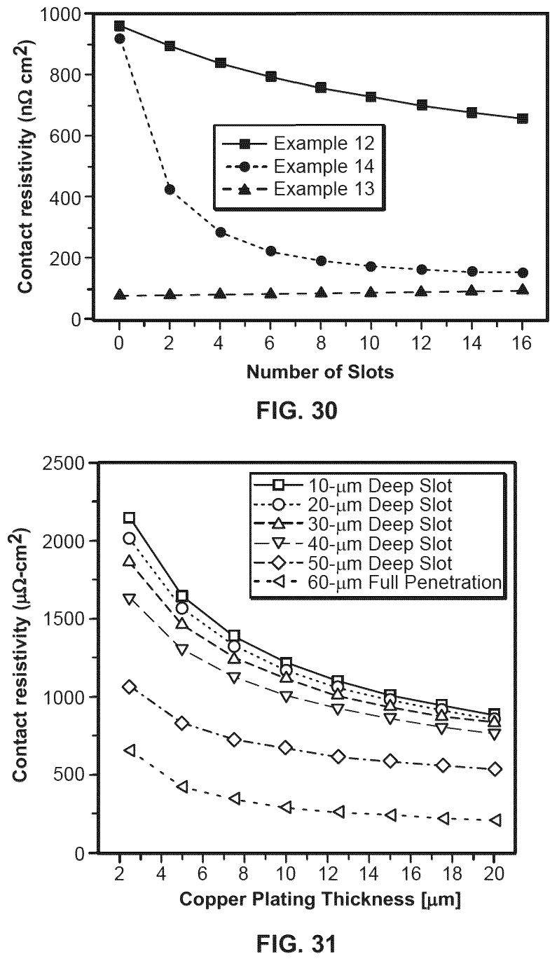

Just like Example 5, the superconductor tape stack in Example 13 has a 2X configuration. Referring to FIG. 30, Example 13 demonstrates that for the 2X configuration, contact resistivity remains relatively low (less than 100 nΩ·cm²) and has a shallow increase in contact resistivity as the number of slots increases.

The superconductor tape stack in Example 14 has the same construction as the superconductor tape stack in Example 4 except that the superconductor tape stack in Example 14 has superconductor tapes each having a Cu40-W60 substrate, slots through the superconductor film and buffer layer stack, and the slots are filled with a silver metal layer and a copper stabilizer layer. Example 14 demonstrates that slots and a relatively conductive substrate can help to reduce significantly contact resistivity as the number of slots increases. Referring to FIG. 30, contact resistivity significantly decreases with just one slot. The contact resistivity continues to decrease as the number of slots, but not at the same rate as between no slots and one slot. The contact resistivity for Example 14 having 16 slots approaches the contact resistivity of Example 12 when Example 12 has 16 slots. As previously addressed, I_{c} for a superconductor tape can decrease as the number of slots increase. Example 14 with 8 slots may provide a good balance between I_{c} and contact resistivity.

The number of slots can be selected such that a contact resistivity is in a range from 5 nΩcm² to 300 nΩcm² while the I_{c} is at least 80 A/4 mm-width at 77 K, 0 T. After reading this specification, skilled artisans will be able to determine the number of slots to be used to meet the needs or desires for a particular application.

Similar to Examples 4 to 7, in Examples 12 to 14, the best electrical performance occurs with a superconductor tape stack having a 2X configuration. Slots can help a superconductor tape stack having an F2B configuration have electrical performance closer to a superconductor tape stack having a 2X configuration. As the resistivity of the substrates are reduced and slots are used, the contact resistivity of a superconductor tape stack having an F2B configuration can be close to the contact resistivity of a superconductor tape having a 2X configuration.

### Examples 15 to 32—Different Depths of Slots and Stabilizer Layer Thicknesses

Examples 15 to 32 demonstrate the change in contact resistivity as a function of the depths and number of slots within superconductor tapes and the thickness of copper stabilizer layer increases. In Examples 15 to 32, the superconductor tape stacks have F2B configurations. Each of the superconductor tapes includes a substrate is made of a Hastelloy®-brand alloy having a 50 μm thickness and a dielectric buffer layer. The table below lists the examples and their corresponding slot depths. In Examples 20, 26, and 32, the slot extends through the entire thickness of the substrate.

| | | | | | | |
|---|---|---|---|---|---|---|
| Example | 15, | 16, | 17, | 18, | 19, | 20, |
| | 21, | 22, | 23, | 24, | 25, | 26, |
| | 27 | 28 | 29 | 30 | 31 | 32 |
| Slot depth (μm) | 10 | 20 | 30 | 40 | 50 | 60 |

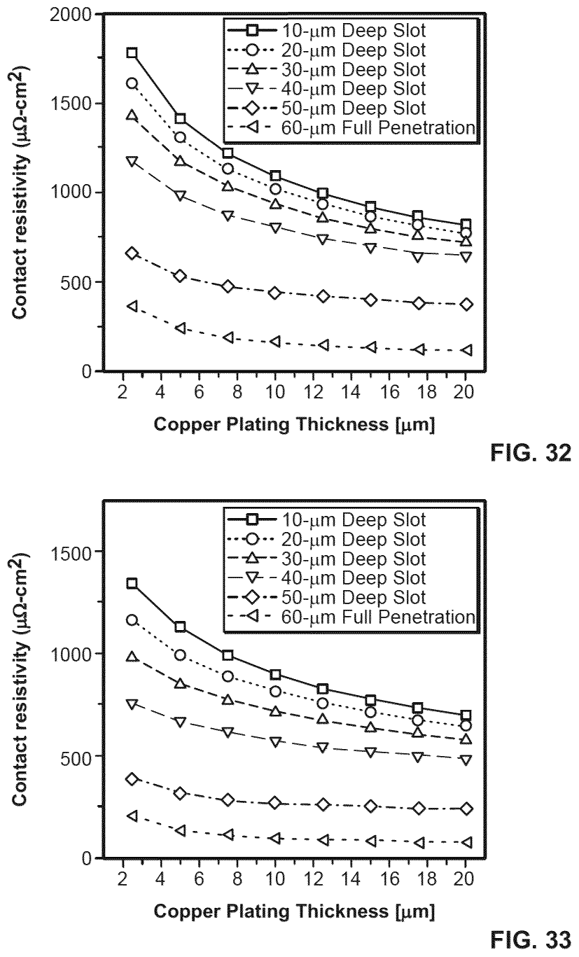

Slot depths are measured from the top of the copper stabilizer layer outside the slot to the bottoms of the slots. Referring to FIG. 31, Examples 15 to 20 have 2 slots, referring to FIG. 32, Examples 21 to 26 have 4 slots, and referring to FIG. 33, Examples 27 to 32 have 8 slots.

FIGS. 31 to 33 illustrate that a thicker Cu stabilizer layer and deeper slots demonstrate better current sharing, and therefore, have lower contact resistivity. Where the slots fully penetrate the entire substrate (Examples 20, 26, and 32), the contact resistivity is nearly 1/(n+1) as compared to a substantially identical superconductor tape except without any slot, where n is the number of slots.

### Examples 33 to 35—Conductive Buffer Layer Stack

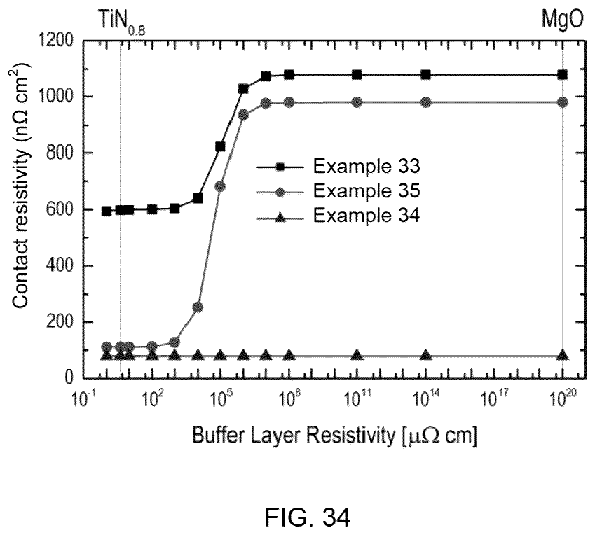

Examples 33 to 35 demonstrate the change in contact resistivity as a function of the resistivity of the buffer layer stack. In FIG. 34, the resistivities of TiN_{0.8} and MgO are marked on the plots.

Example 33 corresponds to a superconductor tape stack with a F2B configuration, where the superconductor tapes have substrates made of a Hastelloy®-brand alloy. Other than the resistivity of the buffer layer stack, Example 33 is similar to Example 1. Referring to FIG. 34, Example 33 demonstrates that the contact resistivity can be lowered as the buffer layer resistivity decreases; however, the contact resistivity remains relatively high (at least 600 nΩ·cm²).

Just like Example 2, the superconductor tape stack in Example 34 has a 2X configuration. Referring to FIG. 34, Example 34 demonstrates that for the 2X configuration, contact resistivity remains relatively low (less than 100 nΩ·cm²) and substantially constant as the composition of the buffer layer stack changes.

Example 35 is similar to Example 1 except the dielectric buffer layer stack is replaced by a conductive buffer layer stack, and the substrate is replaced by a more conductive substrate. Example 35 demonstrates that a conductive buffer layer stack and a relatively conductive substrate can help to reduce significantly contact resistivity. Example 35 corresponds to a superconductor tape stack with a F2B configuration, where each of the superconductor tapes has Cu40-W60 substrates. Referring to FIG. 34, contact resistivity starts to decrease where the buffer layer stack has a resistivity of 1×10⁸ nΩ·cm, and significantly decreases as the resistivity of the buffer layer stack decreases from 1×10⁶ nΩ·cm to 1×10³ nΩ·cm. With a Cu40-W60 substrate and a buffer layer stack having a resistivity below 1×10³ nΩ·cm, the contact resistivity for a F2B configuration can be comparable to a superconductor tape stack with a 2X configuration.

### Examples 36 to 53—Different Slots, Substrate, and Buffer Layer Resistivities

Examples 36 to 53 demonstrate how contact resistivity changes with changes in resistivity of the substrate and buffer layer stack and number of slots within superconductor tapes. In Examples 36 to 53, the superconductor tape stacks have F2B configurations. The table below lists the examples and resistivities of the corresponding substrates.

| | | | | | | |
|---|---|---|---|---|---|---|
| Example | 36, | 37, | 38, | 39, | 40, | 41, |
| | 42, | 43, | 44, | 45, | 46, | 47, |
| | 48 | 49 | 50 | 51 | 52 | 53 |
| Substrate | 124 | 57 | 37 | 7.3 | 6.5 | 3.4 |
| resistivity (nΩ · cm) | | | | | | |

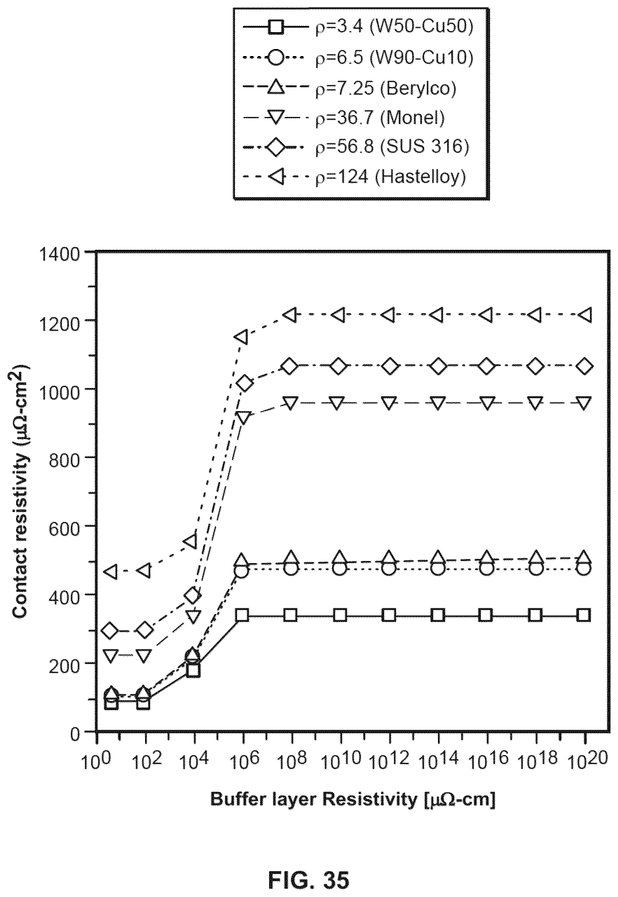

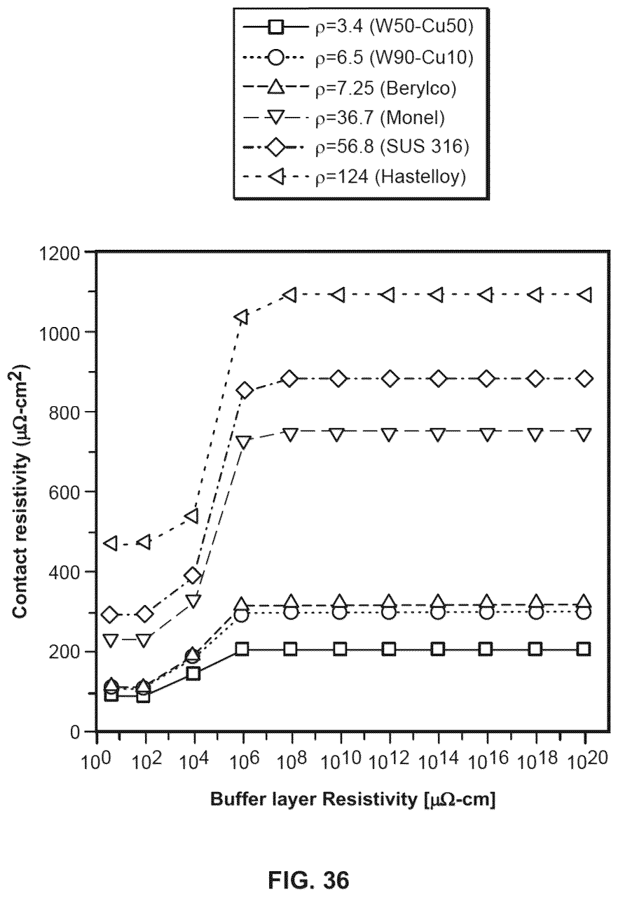

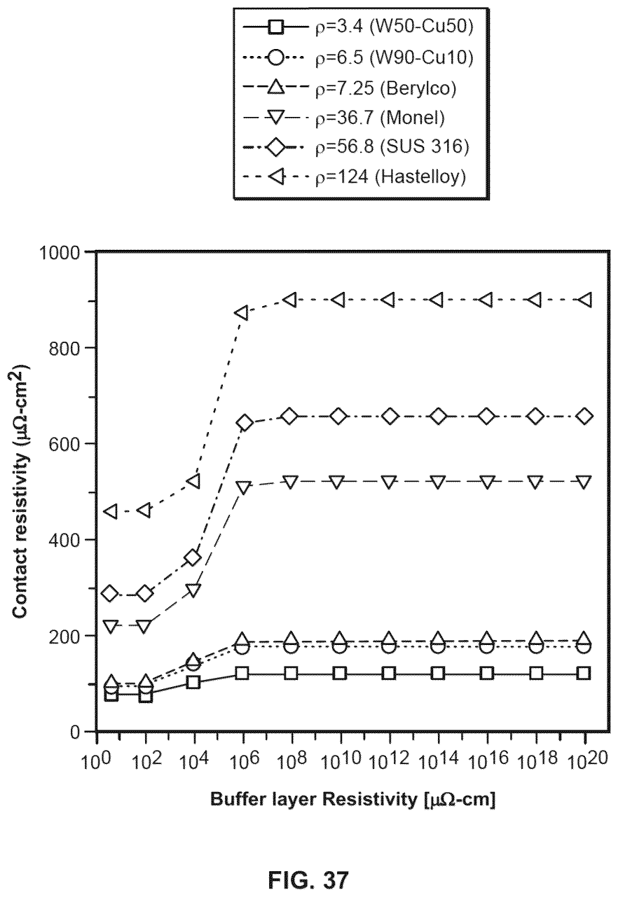

Referring to FIG. 35, Examples 36 to 41 have 2 slots, referring to FIG. 36, Examples 42 to 47 have 4 slots, and referring to FIG. 37, Examples 48 to 53 have 8 slots. More slots result in lower contact resistivity. Within each of the figures, each curve represents a different substrate material.

In FIGS. 35 to 37, the curves for contact resistivity as a function of resistivity of the buffer layer stacks for each of the substrate materials have similar shapes to the curves in FIG. 34. Most of the change in contact resistivity occurs as the resistivity in the buffer layer stack is reduced from 1×10⁶ μΩ·cm to 1×10² nΩ·cm. Resistivities of substrates of at most 70 nΩ·cm can achieve contact resistivities less than 400 nΩ·cm² when the buffer layer stack has a resistivity of at most 1×10³ nΩ·cm. Resistivities of substrates of at most 10 nΩ·cm can achieve contact resistivities of approximately 100 nΩ·cm² when the buffer layer stack has a resistivity of at most 1×10² nΩ·cm. For each of the substrate materials, the contact resistivity is substantially constant as the buffer layer resistivity decreases below 1×10² μΩ·cm.

Thus, contact resistivities for a superconductor tape stack having a 2X configuration can be achieved for a superconductor tape stacks with F2B configurations where at least one of the superconductor tapes has a substrate with a relatively low resistivity, slots extending through the superconductor film and buffer layer stack and filled with a conductive material, and a conductive buffer layer stack.

### Examples 54 to 57—Different Thicknesses of Cu Along Sidewalls of Tapes

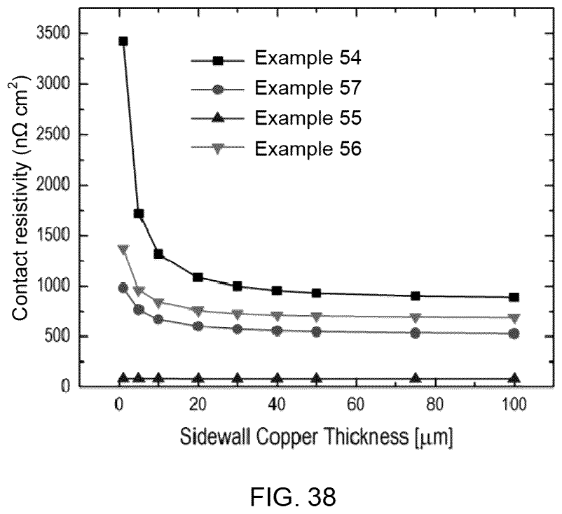

Examples 54 to 57 demonstrate contact resistivity as a function of the thickness of Cu (stabilizer layer) along sidewall (edges in the thickness direction) of the superconductor tapes. The construction of Examples 54 to 57 is same as Examples 4 to 7, respectively, except the thickness of Cu along the sidewalls of the superconductor tapes is varied. Example 54 (Hastelloy®-brand alloy substrates, dielectric buffer layer stack, no slots) demonstrates that the contact resistivity can be lowered when thickness of Cu along the sidewalls of the superconductor tapes increases; however, the contact resistivity remains relatively high (over 800nΩ·cm²) as seen in FIG. 38.

Just like Example 5, the superconductor tape stack in Example 55 has a 2X configuration. Referring to FIG. 38, Example 55 demonstrates that for the 2X configuration, contact resistivity remains relatively low (less than 100 nΩ·cm²) and substantially constant as the thickness of the Cu along the sidewall changes.

Example 56 (Hastelloy®-brand alloy substrates, dielectric buffer layer stack, has slots) demonstrates that slots can help to reduce significantly contact resistivity as the thickness of the Cu along the sidewalls is 5 μm or greater. Referring to FIG. 38, the contact resistivity reaches approximately 700 nΩ·cm² starting at a Cu sidewall thickness of 20 μm and remains relatively constant as the Cu thickness increases.

Example 57 (Hastelloy®-brand alloy substrates, conductive buffer layer stack, no slots) demonstrates that a conductive buffer layer stack can help to reduce significantly contact resistivity as the thickness of the Cu along the sidewalls is 5 μm or greater. Referring to FIG. 38, the contact resistivity reaches approximately 500 nΩ·cm² starting at a Cu sidewall thickness of 20 μm and remains relatively constant as the thickness increases.

For superconductor tape stacks with F2B configurations, the thickness of Cu along sidewalls of the superconductor tapes can help reduce the contact resistivity but only to a certain point. When the Cu sidewall thickness is increased beyond 20 μm, the contact resistivity remains relatively constant for each superconductor tape stack.

Superconductor tape stacks as described herein can have good current sharing characteristics. A superconductor tape stack with a 2X configuration have great current sharing characteristics and low contact resistivity. The current sharing characteristics and contact resistivity of the superconductor tape stack with the 2X configuration is not significantly affected by enhancements that greatly help superconductor tape stacks with a F2B configuration.

Current sharing and contact resistivity for superconductor tape stacks with a F2B configuration can be greatly improved with enhancements. Such enhancements can allow a superconductor tape stack to have current sharing and contact resistivities that approach current sharing and contact resistivity seen with a 2X configuration. The superconductor tapes are coupled to each other using an electrically conductive material that allows good electrical contact to be made to each of the superconductor tapes. Contact resistance can be improved using slotted superconductor tapes, conductive buffer layer stacks, relatively lower resistivity substrates, thinner substrates, a thicker stabilizer layer along the sidewalls of the tapes, or any combination thereof. After reading this specification, skilled artisans will appreciate that they have many different options to improve contact resistivity of superconductor tape stack having a F2B configuration.

A double-sided superconductor tape may be improved with any of the enhancements that are described with respect to the superconductor tape stacks having a F2B configuration. The double-sided superconductor tape with any of the enhancements can be useful for the double-sided tape is used by itself or another application outside a superconductor tape stack.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A superconductor tape stack, comprising a first superconductor tape and a second superconductor tape, wherein the first superconductor tape and the second superconductor tape are arranged in a face-to-back configuration within the superconductor tape stack, and the superconductor tape stack has a contact resistivity of at most 700 nΩcm².

2. The superconductor tape stack of claim 1, wherein each of the first superconductor tape and the second superconductor tape includes a substrate.

3. The superconductor tape stack of claim 2, wherein the substrate of the first superconductor tape, the second superconductor tape, or each of the first superconductor tape and the second superconductor tape has a resistivity in a range from 2 μΩcm to 50 μΩcm.

4. The superconductor tape stack of claim 1, wherein each of the first superconductor tape and the second superconductor tape comprises a substrate and a buffer layer stack along a side of the substrate, and the buffer layer stack of the first superconductor tape, the second superconductor tape, or each of the first superconductor tape and the second superconductor tape has a resistivity of at most 1×10⁸ μΩcm.

5. The superconductor tape stack of claim 4, wherein the buffer layer stack comprises TiN, LaNiO₃, SrVO₃, SrRuO₃, Nb-doped SrTiO₃, or a combination thereof.

6. The superconductor tape stack of claim 1, wherein:
each of the first superconductor tape and the second superconductor tape comprises a buffer layer stack and a REBCO film,
a slot extends through the REBCO film and the buffer layer stack of the first superconductor tape, the second superconductor tape, or each of the first superconductor tape and the second superconductor tape,
a conductive material at least partly fills the slot, wherein the conductive material has a resistivity less than 1 mΩcm, and
a critical current of the first superconductor tape, the second superconductor tape, or each of the first superconductor tape and the second superconductor tape having the slot is at least 80 A/4 mm width at 77 K, 0 T.

7. The superconductor tape stack of claim 1, wherein:
the first superconductor tape, the second superconductor tape, or each of the first superconductor tape and the second superconductor tape comprises:
a substrate having a first side and a second side opposite the first side;
a first REBCO film along the first side of the substrate; and
a second REBCO film along the second side of the substrate,
each of the first superconductor tape and the second superconductor tape has a length,
at least 11% of the length of the first superconductor tape overlaps the second superconductor tape, and
at least 11% of the length of the second superconductor tape is overlapped by the first superconductor tape.

8. The superconductor tape stack of claim 1, further comprising an electrically conductive material disposed between the first superconductor tape and the second superconductor tape, wherein the electrically conductive material has a resistivity of at most 35 μΩcm.

9. A magnetic coil, comprising the superconductor tape stack of claim 1, wherein the superconductor tape stack is at least part of a winding of the magnetic coil.

10. A cable, comprising the superconductor tape stack of claim 1, wherein the superconductor tape stack is at least part of the cable.

11. A superconductor tape stack, comprising a first superconductor tape and a second superconductor tape, wherein each of the first superconductor tape and the second superconductor tape includes a substrate and a superconductor film adjacent to the substrate, the first superconductor tape and the second superconductor tape are arranged in a face-to-back configuration within the superconductor tape stack, and the substrate of the first superconductor tape, the second superconductor tape, or each of the first superconductor tape and the second superconductor tape has a resistivity of at most 50 μΩcm.

12. The superconductor tape stack of claim 11, wherein the substrate of the first superconductor tape, the second superconductor tape, or each of the first superconductor tape and the second superconductor tape has a yield strength of at least 300 MPa.

13. The superconductor tape stack of claim 11, wherein the substrate of the first superconductor tape, the second superconductor tape, or each of the first superconductor tape and the second superconductor tape comprises Cu and W, wherein the substrate has 20 wt. % Cu to 70 wt. % Cu and 30 wt. % W to 80 wt. % W.

14. A superconductor tape stack, comprising a first superconductor tape and a second superconductor tape, wherein each of the first superconductor tape and the second superconductor tape includes a substrate and a buffer layer stack along a side of the substrate, the first superconductor tape and the second superconductor tape are arranged in a face-to-back configuration within the superconductor tape stack, and the buffer layer stack of the first superconductor tape, the second superconductor tape, or each of the first superconductor tape and the second superconductor tape has a resistivity of at most 1×10⁸ μΩcm.

15. The superconductor tape stack of claim 14, wherein the resistivity of the buffer layer stack is in a range from 4 μΩcm to 1×10⁸ μΩcm.

16. The superconductor tape stack of claim 14, wherein the buffer layer stack comprises TiN, LaNiO₃, SrVO₃, SrRuO₃, Nb-doped SrTiO₃, or a combination thereof.

17. A superconductor tape stack, comprising a first superconductor tape and a second superconductor tape, wherein:
each of the first superconductor tape and the second superconductor tape includes a buffer layer stack and a REBCO film, and the first superconductor tape and the second superconductor tape are arranged in a face-to-back configuration within the superconductor tape stack,
a slot extends through the REBCO film and the buffer layer stack of the first superconductor tape, the second superconductor tape, or each of the first superconductor tape and the second superconductor tape,
a conductive material at least partly fills the slot, wherein the conductive material has a resistivity less than 1 mΩcm, and
a critical current of the first superconductor tape, the second superconductor tape, or each of the first superconductor tape and the second superconductor tape having the slot is at least 80 A/4 mm width at 77 K, 0 T.

18. The superconductor tape stack of claim 17, wherein a width of the slot is in a range from 5 μm to 200 μm.

19. A superconductor tape stack, comprising a first superconductor tape and a second superconductor tape, wherein:
the first superconductor tape, the second superconductor tape, or each of the first superconductor tape and the second superconductor tape comprises:
a substrate having a first side and a second side opposite the first side;
a first REBCO film along the first side of the substrate; and
a second REBCO film along the second side of the substrate,
each of the first superconductor tape and the second superconductor tape has a length,
at least 11% of the length of the first superconductor tape overlaps the second superconductor tape, and
at least 11% of the length of the second superconductor tape is overlapped by the first superconductor tape.

20. The superconductor tape stack of claim 19, wherein a contact resistivity of the superconductor tape stack is in a range from 5 nΩcm² to 700 nΩcm².
